(19) United States
(12) Patent Application Publication
(10) Pub. No.: US 2020/0220773 A1
(43) Pub. Date: Jul. 9, 2020

(54) CONTROL DEVICE, COMMUNICATION SYSTEM, AND COMMUNICATION METHOD

(71) Applicant: NEC Corporation, Tokyo (JP)

(72) Inventor: Kenichi TERASHIMA, Tokyo (JP)

(73) Assignee: NEC Corporation, Tokyo (JP)

(21) Appl. No.: 16/647,287

(22) PCT Filed: Sep. 18, 2018
(86) PCT No.: PCT/JP2018/034386

§ 371 Date: Mar. 13, 2020

(30) Foreign Application Priority Data
Sep. 28, 2017 (JP) 2017-187788

(51) Int. Cl. H04L 12/24; H04L 12/26; H04L 29/08

(52) U.S. Cl. CPC H04L 41/0663; H04L 69/321; H04L 43/0817; H04L 41/0213

(57) ABSTRACT

The purpose of the present invention is to enable a system so highly fault-resistant that multilayer network communication continues even when a fault occurs in a higher-order layer. The system is characterized in that in a second layer which is of a higher order than a first layer, a data processing method called for by the addressee for the data is transmitted to a second communication device for transmitting transmission port information indicating a port to be used in transmitting the data to a first communication device for transmitting the data in the first layer, and when an occurrence of fault is detected in the second communication device, the transmission port information determined on the basis of the addressee for the data is transmitted to the first communication device.

### TECHNICAL FIELD

The present invention relates to a control device, a communication system, and a communication method.

### BACKGROUND ART

Methods using generalized multi-protocol label switching (GMPLS) (for example, Non-Patent Literature 1 (NPL1)) and a path computation element (PCE) (for example, Non-Patent Literature 2 (NPL2)) have been proposed as a fault recovery method in a multilayer network.

For example, Patent Literature 1 (PTL1) describes that in order to maintain connection in a higher layer even when a failure occurs in a line in a lower layer, a management node sets a path bypassing the failure in the lower layer to a communication node in the higher layer.

For example, Patent Literature 2 (PTL2) describes, when a failure occurs on a path in an optical layer being a lower layer, coping with the failure by changing a path in an electrical layer being a higher layer and switching to an optical path on which a failure is not occurring.

### CITATION LIST

### Non Patent Literature

NPL1: IETF RFC 4426 “Generalized Multi-Protocol Label Switching (GMPLS) Recovery Functional Specification”

NPL2: IETF RFC 4655 “A Path Computation Element (PCE)-Based Architecture”

### Patent Literature

PTL1: Japanese Patent Application Laid-open No. 2005-223522

PTL2: Japanese Patent Application Laid-open No. 2015-005824

### SUMMARY OF INVENTION

### Technical Problem

However, a case of a failure occurring in a higher layer of a multilayer network but not occurring in a lower layer is not considered in PTL1 and PTL2.

PTL1 assumes performing setting in a higher layer when a failure occurs in a lower layer and therefore does not consider a case of a failure occurring in a higher layer.

For example, PTL2 has a problem that, even when a communication node in a lower layer is normally operating, a setting in the lower layer is changed according to a setting change in a higher layer. Setting a higher layer and a lower layer individually in order to resolve the problem incurs costs such as time and traffic for failure recovery.

Accordingly, an object of the present invention is to provide a control device, a communication system, and a communication method that provide a highly fault-tolerant system continuing communication in a multilayer network even when a failure occurs in a higher layer.

### Solution to Problem

A control device according to an aspect of the present invention includes a means for: transmitting a processing method of data based on a destination of the data to a second communication device transmitting, in a second layer higher than a first layer, transmission port information indicating a port from which the data are transmitted, to a first communication device transmitting the data in the first layer; and, when detecting occurrence of a failure in the second communication device, transmitting the transmission port information determined based on a destination of the data to the first communication device.

A communication system according to an aspect of the present invention includes: a first communication device transmitting data in a first layer; a second communication device transmitting, to the first communication device, transmission port information indicating a port from which the data are transmitted, in a second layer higher than the first layer; and a control device transmitting a processing method of the data based on a destination of the data to the second communication device and when detecting occurrence of a failure in the second communication device, transmitting the port information determined based on a destination of the data to the first communication device.

A communication method according to an aspect of the present invention includes:

transmitting a processing method of data based on a destination of the data to a second communication device transmitting, in a second layer higher than a first layer, transmission port information indicating a port from which the data are transmitted, to a first communication device transmitting the data in the first layer; and, when detecting occurrence of a failure in the second communication device, transmitting the port information determined based on a destination of the data to the first communication device.

### Advantageous Effects of Invention

A control device, a communication system, and a communication method, according to the present invention, can provide a highly fault-tolerant system continuing communication in a multilayer network even when a failure occurs in a higher layer.

### BRIEF DESCRIPTION OF DRAWINGS

FIG. 1 is a diagram illustrating a configuration example of a multilayer network according to one example embodiment of the present invention.

FIG. 2 is a block diagram illustrating a configuration example of a control device 10A according to the one example embodiment of the present invention.

FIG. 3 is a block diagram illustrating a configuration example of a second communication device 20A according to the one example embodiment of the present invention.

FIG. 4 is a diagram illustrating a configuration example of a multilayer network according to a first example embodiment and an example of a data transfer path.

FIG. 5 is a diagram illustrating an example of a state in which a failure has occurred in the multilayer network illustrated in FIG. 4.

FIG. 6 is a diagram illustrating an example of a state in which the failure occurring in the multilayer network illustrated in FIG. 5 is coped with.

FIG. 7 is a diagram illustrating another configuration example of the multilayer network according to the first example embodiment and an example of a data transfer path.

FIG. 8 is a block diagram illustrating a configuration example of a controller 10 according to the first example embodiment.

FIG. 9 is an example of information held by a network information storage unit in the controller 10 according to the first example embodiment.

FIG. 10 is a block diagram illustrating a configuration example of a higher level communication node 20 according to the first example embodiment.

FIG. 11 is an example of information held by a processing method storage unit 23 in the higher level communication node 20 according to the first example embodiment.

FIG. 12 is a block diagram illustrating a configuration example of a lower level communication node 30 according to the first example embodiment.

FIG. 13 is an example of information held by a processing method storage unit 33 in the lower level communication node 30 according to the first example embodiment.

FIG. 14 is a diagram illustrating an example of a state in which a failure has occurred in the multilayer network illustrated in FIG. 7.

FIG. 15 is a sequence diagram illustrating an operation example of coping with the failure occurring in the multilayer network illustrated in FIG. 14.

FIG. 16 is an example of a processing method held by the processing method storage unit 33 in a lower level communication node 30-1 before and after the occurrence of the failure in a higher level communication node 20-1 illustrated in FIG. 14.

FIG. 17 is a diagram illustrating an example of a state in which the failure occurring in the multilayer network illustrated in FIG. 14 is coped with.

FIG. 18 is a sequence diagram illustrating another operation example of coping with a failure occurring in the multilayer network according to the first example embodiment.

FIG. 19 is an example of a processing method held by the processing method storage unit 33 in a lower level communication node 30-2 before and after the occurrence of the failure in a higher level communication node 20-2 illustrated in FIG. 18.

FIG. 20 is a diagram illustrating an example of a state in which the failure occurring in the multilayer network illustrated in FIG. 18 is coped with.

FIG. 21 is a diagram illustrating a configuration example of a multilayer network according to a second example embodiment and an example of a data transfer path.

FIG. 22 is a diagram illustrating an example of a state in which a failure occurs in the multilayer network illustrated in FIG. 21.

FIG. 23 is a diagram illustrating an example of a state in which the failure occurring in the multilayer network illustrated in FIG. 21 is coped with.

FIG. 24 is a diagram illustrating another configuration example of the multilayer network according to the second example embodiment and an example of a data transfer path.

FIG. 25 is a block diagram illustrating a configuration example of a medium-level communication node 40 according to the second example embodiment.

FIG. 26 is an example of information held by a processing method storage unit 43 in the medium-level communication node 40 according to the second example embodiment.

FIG. 27 is a diagram illustrating an example of a state in which a failure has occurred in the multilayer network illustrated in FIG. 24.

FIG. 28 is a sequence diagram illustrating an operation example of coping with the failure occurring in the multilayer network illustrated in FIG. 24.

FIG. 29 is an example of a processing method held by the processing method storage unit 33 in a lower level communication node 30-1 before and after the occurrence of the failure in the multilayer network illustrated in FIG. 24.

FIG. 30 is a diagram illustrating an example of a state in which the failure occurring in the multilayer network illustrated in FIG. 27 is coped with.

FIG. 31 is a sequence diagram illustrating another operation example of coping with the failure occurring in the multilayer network illustrated in FIG. 27.

FIG. 32 is an example of information held by the processing method storage unit 43 in a medium-level communication node 40-2 after the occurrence of the failure in the multilayer network illustrated in FIG. 27.

FIG. 33 is an example of information held by the processing method storage unit 33 in a lower level communication node 30-2 after the occurrence of the failure in the multilayer network illustrated in FIG. 27.

FIG. 34 is a diagram illustrating another state in which a failure occurring in the multilayer network illustrated in FIG. 24 is coped with.

FIG. 35 is an example of information held by the processing method storage unit 33 in the lower level communication node 30-2 after the failure occurring in the multilayer network illustrated in FIG. 27 is coped with.

FIG. 36 is a diagram illustrating another example of a state in which failures have occurred in the multilayer network illustrated in FIG. 27.

FIG. 37 is an example of information held by the processing method storage unit 33 in a lower level communication node 30-2 before and after the occurrence of the failures in the multilayer network illustrated in FIG. 36.

FIG. 38 is another example of information held by the processing method storage unit 33 in the lower level communication node 30-2 after the occurrence of the failures in the multilayer network illustrated in FIG. 36.

FIG. 39 is a diagram illustrating an example of a state in which the failures occurring in the multilayer network illustrated in FIG. 36 are coped with.

### EXAMPLE EMBODIMENT

### Outline of Example Embodiment

An outline of one example embodiment of the present invention will be described with reference to drawings.

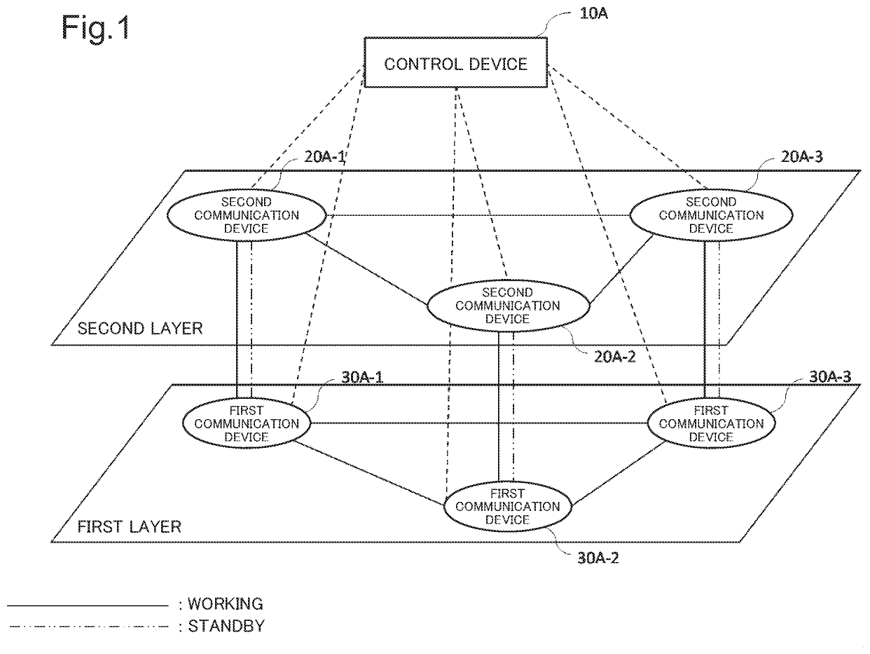

FIG. 1 is a diagram illustrating a configuration example of a multilayer network according to the one example embodiment of the present invention.

The multilayer network according to the one example embodiment of the present invention includes a control device 10A, a second communication device 20A-1, a second communication device 20A-2, and a second communication device 20A-3 that belong to a second layer, and a first communication device 30A-1, a first communication device 30A-2, and a first communication device 30A-3 that belong to a first layer.

Each of the first communication devices 30A (30A-1 to 3) belonging to the first layer is connected to one of the second communication devices 20A (20A-1 to 3) belonging to the second layer through a working interface and one or more standby interfaces.

When a failure occurs at a working interface, the control device 10A instructs a first communication device 30A and a second communication device 20A that use the working interface to use a standby interface.

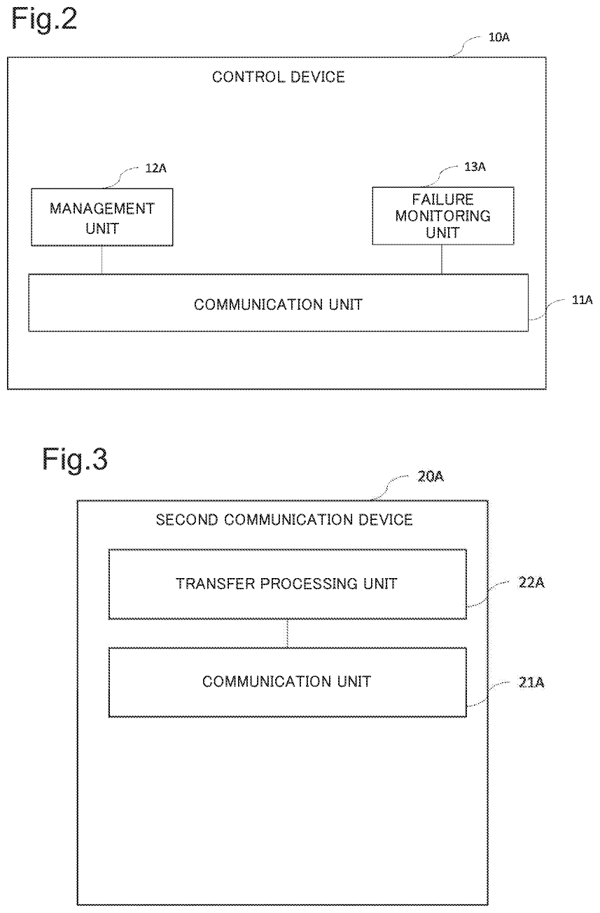

FIG. 2 is a block diagram illustrating a configuration example of the control device 10A according to the one example embodiment of the present invention.

The control device 10A according to the one example embodiment of the present invention includes a communication unit 11A, a management unit 12A, and a failure monitoring unit 13A.

The control device 10A controls the first communication devices 30A and the second communication devices 20A through the communication unit 11A. The control device 10A transmits a data processing method based on a destination of the data to a second communication device 20A.

The failure monitoring unit 13A transmits data for detecting a failure to the second communication devices 20A. The failure monitoring unit 13A detects occurrence of a failure in a second communication device 20A by the second communication device 20A not responding to the data.

The management unit 12A transmits a data processing method based on a destination of the data to a second communication device 20A.

When the failure monitoring unit 13A detects occurrence of a failure in at least one second communication device 20A, the management unit 12A determines transmission port information, based on a destination of data. The management unit 12A transmits the determined transmission port information to a first communication device 30A.

FIG. 3 is a block diagram illustrating a configuration example of a second communication device 20A according to the one example embodiment of the present invention.

The second communication device 20A according to the one example embodiment of the present invention includes a communication unit 21A and a transfer processing unit 22A.

The second communication device 20A transmits, to a first communication device 30A through the communication unit 21A, transmission port information indicating a port from which data are transmitted. The second communication device 20A receives, from the control device 10A through the communication unit 21A, a data processing method based on a destination of the data.

The transfer processing unit 22A determines transmission port information indicating a port from which data are transmitted.

In the following description, information transmitted and received within each layer and information transmitted and received between layers are simply described as data. For example, the data may include packets transmitted and received in an Internet Protocol (IP) layer, frames transmitted and received in a media access control (MAC) layer, and bits transmitted and received in an optical layer.

In the following description, the lower level communication node 30-1, the lower level communication node 30-2, and the lower level communication node 30-3 are simply described as lower level communication nodes 30 unless the nodes need to be individually distinguished. The higher level communication node 20-1, the higher level communication node 20-2, and the higher level communication node 20-3 are also simply described as higher level communication nodes 20 unless the nodes need to be individually distinguished. The medium-level communication node 40-1, the medium-level communication node 40-2, and the medium-level communication node 40-3 are also simply described as medium-level communication nodes 40 unless the nodes need to be individually distinguished.

In the following description, higher level communication nodes 20, medium-level communication nodes 40, and lower level communication nodes 30 are simply described as communication nodes unless the nodes need to be individually distinguished.

### First Example Embodiment

### First Configuration

A first example embodiment of the present invention will be described in detail with reference to drawings.

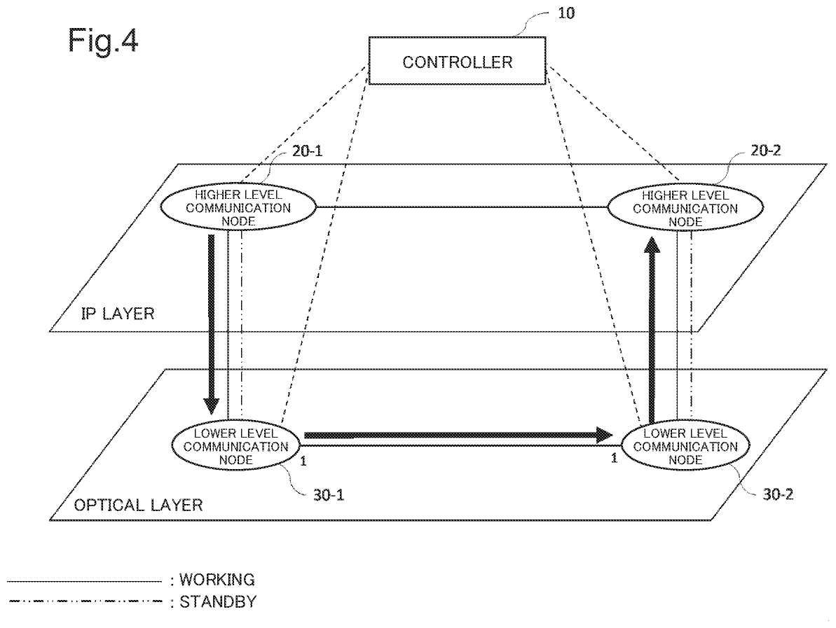

FIG. 4 is a diagram illustrating a configuration example of a multilayer network according to the first example embodiment.

The multilayer network according to the first example embodiment includes a controller 10, a lower level communication node 30-1 and a lower level communication node 30-2 that belong to an optical layer, and a higher level communication node 20-1 and a higher level communication node 20-2 that belong to an IP layer.

The higher level communication nodes 20 belonging to the IP layer mutually transmit and receive data by use of an internet protocol (IP). For example, a higher level communication node 20 transmits information in a unit called a packet acquired by dividing data.

The lower level communication nodes 30 belonging to the optical layer constitute an optical communication network by being mutually connected by physical links. For example, a lower level communication node 30 performs transmission of transmitting information with an optical signal in which a plurality of wavelength signals are multiplexed [wavelength division multiplexing (WDM) transmission].

A higher level communication node 20 belonging to the IP layer and a lower level communication node 30 belonging to the optical layer are connected to one another through two or more interfaces. For example, the interface may use Gigabit Ethernet (1 GbE), 10 GbE, or 100 GbE. Further, for example, the interface may use a serial interface such as a universal serial bus (USB) or Fibre Channel, or a parallel interface such as an Industrial Standard Architecture (ISA) or a peripheral component interconnect (PCI). However, a standard used by the interface is not limited to GbE, USB, ISA, or PCI.

Two types of roles being working and standby are defined for the interface. The working interface is an interface preferentially used between a higher level communication node 20 and a lower level communication node 30. The standby interface is an interface used when the working interface cannot be used due to a failure or the like.

The controller 10 is connected to the higher level communication nodes 20 and the lower level communication nodes 30. For each communication node, the controller 10 performs setting for the communication node to transmit data to another communication node.

For example, the controller 10 determines a path for transmitting data in the IP layer. The controller 10 transmits, to each higher level communication node 20, a data processing method indicating a method for the higher level communication node 20 to process data. In order to transmit data on the determined path, the controller 10 determines processing used for data transfer in the optical layer. The controller 10 transmits, to each lower level communication node 30, transmission port information indicating a port from which the lower level communication node 30 transmits data. When a network failure occurs, the controller 10 performs setting for continuing communication on the higher level communication node 20 and the lower level communication nodes 30 Operation of First Configuration

An operation before occurrence of a failure and a reactive operation performed when a failure occurs, according to the first example embodiment of the present invention, will be described by use of FIG. 4 to FIG. 6.

Arrows illustrated in FIG. 4 indicate an example of a data transfer path being a path for transmitting data from a higher level communication node 20-1 to a higher level communication node 20-2. Numerals described beside lower level communication nodes 30 in FIG. 4 to FIG. 6 denote port numbers.

The higher level communication node 20-1 determines a data processing method for transmitting data to the destination. Specifically, as a processing method of data to be transmitted to the higher level communication node 20-2, the higher level communication node 20-1 determines to instruct the lower level communication node 30-1 to transmit the data from a port 1.

The higher level communication node 20-1 transmits, to the lower level communication node 30-1, transmission port information indicating a port from which the lower level communication node 30-1 transmits data. Specifically, the higher level communication node 20-1 transmits a port number determined as transmission port information and data to the lower level communication node 30-1. At this time, the higher level communication node 20-1 transmits the data to the lower level communication node 30-1 by use of a working interface.

The lower level communication node 30-1 transmits received data from a port with the specified number. Specifically, the lower level communication node 30-1 transmits the received data from the port 1.

The lower level communication node 30-2 transmits received data to the higher level communication node 20-2.

The higher level communication node 20-2 receiving data from the lower level communication node 30-2 refers to the received data and when confirming that the own node is the destination, ends data transfer.

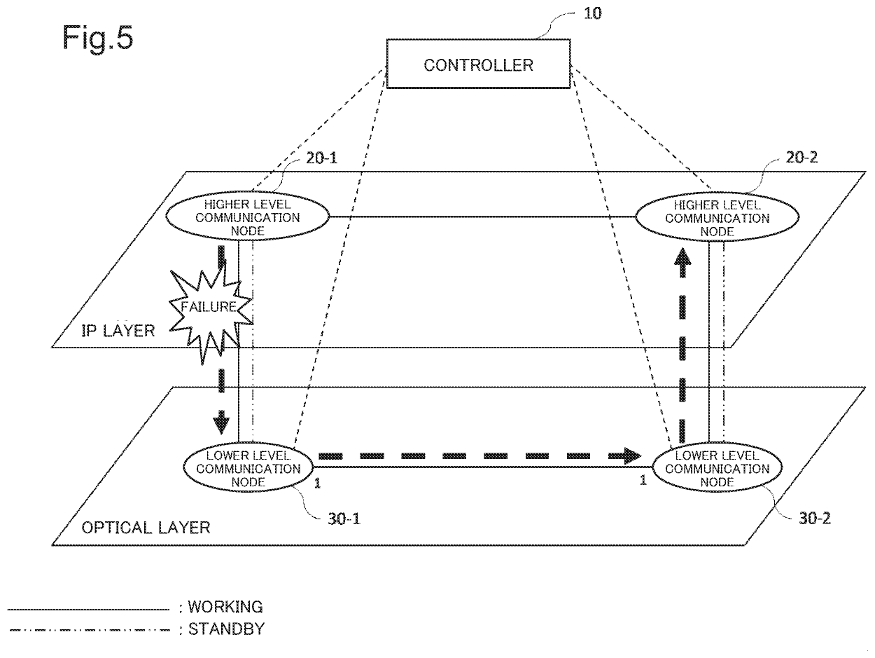

FIG. 5 is a diagram illustrating an example of a state in which a failure has occurred at an interface between the higher level communication node 20-1 and the lower level communication node 30-1 in the multilayer network illustrated in FIG. 4. For example, a failure occurring at an interface refers to a state in which a port on a communication node cannot be used or a state in which a line connecting a communication node and another communication node is disconnected.

When a failure occurs at the interface between the higher level communication node 20-1 and the lower level communication node 30-1, the higher level communication node 20-1 cannot transmit data to the lower level communication node 30-1. Consequently, the data are not transmitted from the lower level communication node 30-1 to the lower level communication node 30-2 and from the lower level communication node 30-2 to the higher level communication node 20-2. Accordingly, although the higher level communication node 20-1, the higher level communication node 20-2, the lower level communication node 30-1, and the lower level communication node 30-2 are in a state in which data can be processed, the higher level communication node 20-1 cannot transmit the data to the higher level communication node 20-2.

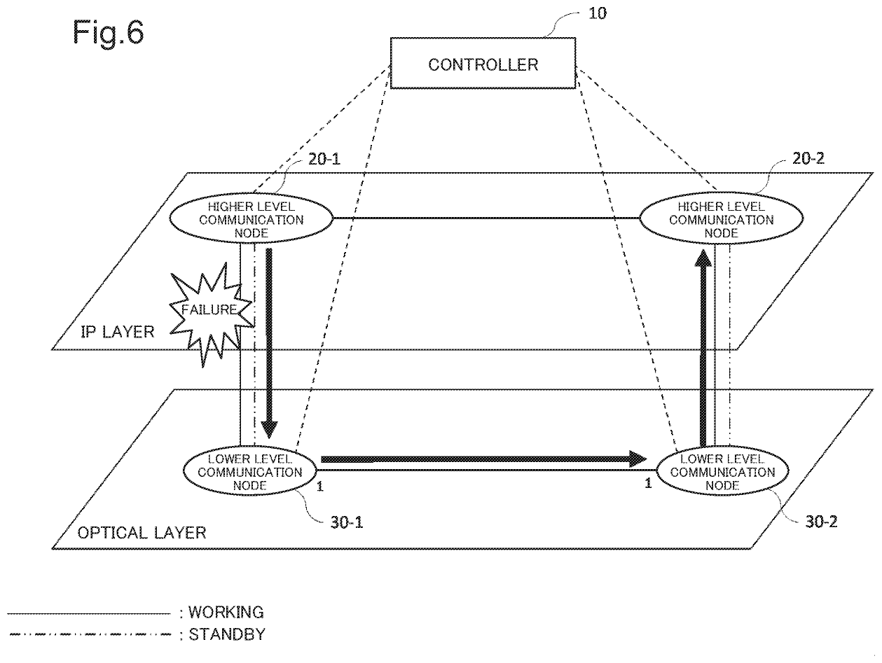

FIG. 6 is a diagram illustrating an example of a state in which the failure occurring in the multilayer network illustrated in FIG. 5 is coped with.

The controller 10 detects occurrence of a failure at the interface between the higher level communication node 20-1 and the lower level communication node 30-1. Specifically, the controller 10 receives a notification indicating that a failure is occurring at the interface from the higher level communication node 20-1. For example, the controller 10 may detect a failure by receiving a notification indicating that a failure is occurring at the interface from the lower level communication node 30-1.

The controller 10 instructs the higher level communication node 20-1 and the lower level communication node 30-1 to switch the interface to be used. Specifically, the controller 10 instructs the higher level communication node 20-1 and the lower level communication node 30-1 to switch the interface used between the higher level communication node 20-1 and the lower level communication node 30-1 from the working interface to a standby interface. By using the standby interface in place of the working interface at which the failure has occurred, the higher level communication node 20-1 can transmit data to the lower level communication node 30-1.

The controller 10 may instruct the higher level communication node 20-1 to switch back from the standby interface to the working interface after the failure occurring at the working interface is cleared. For example, the controller 10 may give an instruction to switch to the working interface with occurrence of a failure at the standby interface as a trigger.

As described above, when detecting occurrence of a failure at a working interface in the first configuration, the controller 10 instructs the higher level communication node 20 and the lower level communication node 30 to use a standby interface. Consequently, a highly fault-tolerant system continuing communication in the multilayer network even when a failure occurs at an interface between communication nodes in different layers can be provided.

### Second Configuration

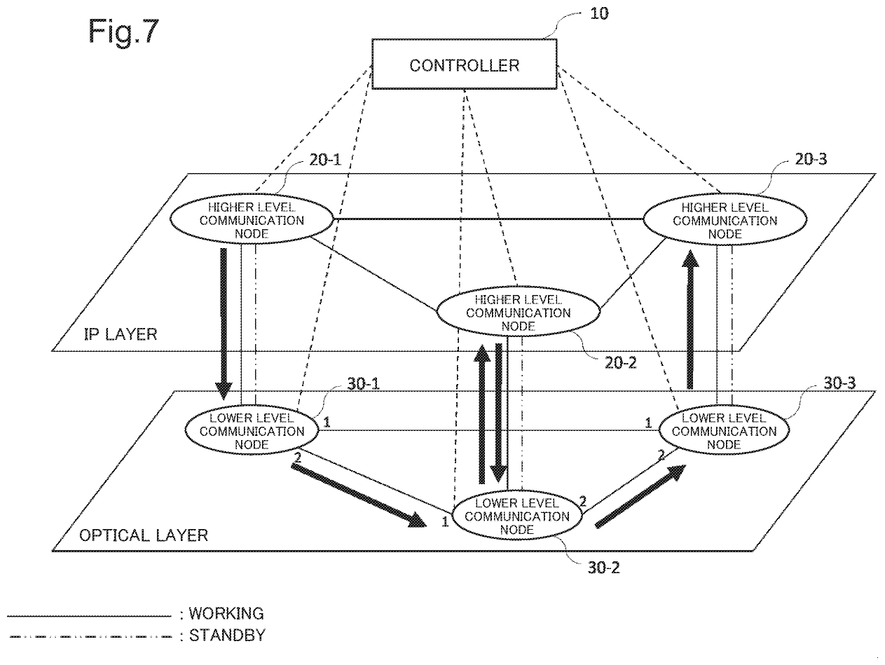

FIG. 7 is a diagram illustrating a configuration example of the multilayer network according to the first example embodiment. FIG. 7 illustrates a configuration acquired by adding a higher level communication node 20-3 and a lower level communication node 30-3 to the configuration of the multilayer network illustrated in FIG. 6.

The multilayer network according to the first example embodiment includes a controller 10, a lower level communication node 30-1, a lower level communication node 30-2, and the lower level communication node 30-3 that belong to an optical layer, and a higher level communication node 20-1, a higher level communication node 20-2, and the higher level communication node 20-3 that belong to an IP layer. A higher level communication node 20 and a lower level communication node 30 are connected through a plurality of interfaces.

Arrows illustrated in FIG. 7 indicate an example of a data transfer path being a path for transmitting data from the higher level communication node 20-1 to the higher level communication node 20-3. Numerals described beside lower level communication nodes in FIG. 7 denote port numbers.

The controller 10 is connected to the higher level communication nodes 20 and the lower level communication nodes 30. The controller 10 performs setting for transmitting data to another communication node on each of the higher level communication nodes 20 and the lower level communication nodes 30.

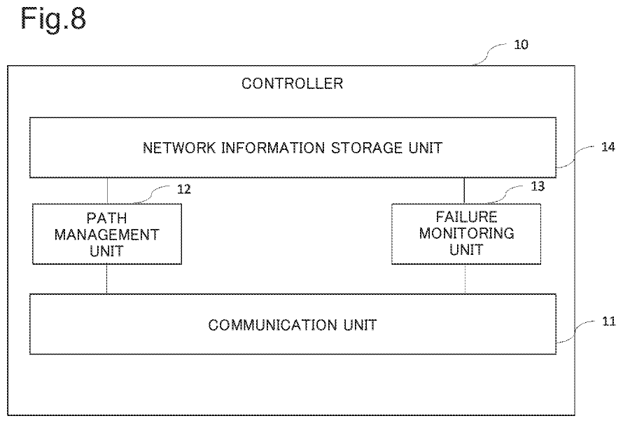

FIG. 8 is a block diagram illustrating a configuration example of the controller 10 according to the first example embodiment.

The controller 10 includes a communication unit 11, a path management unit 12, a failure monitoring unit 13, and a network information storage unit 14.

The path management unit 12 receives data from a communication node through the communication unit 11. The path management unit 12 refers to the network information storage unit 14 and determines a path for transmitting the data received from the communication node to the destination. The path management unit 12 determines a processing method for transmitting the data on the determined path. The path management unit 12 transmits the determined processing method to communication nodes through the communication unit 11.

For example, when receiving data from a communication node with an IP address 12.34.56.78 to a communication node with an IP address 34.56.78.90, the path management unit 12 refers to the network information storage unit 14. The path management unit 12 determines a path for transmitting the data. For example, the path management unit 12 determines to transmit the data in an order of the lower level communication node 30-1—the lower level communication node 30-2—the lower level communication node 30-3. In order to transmit the data on the determined path, the path management unit 12 determines ports for transmitting the data. The path management unit 12 determines to transmit the data by use of ports in an order of a port 2 on the lower level communication node 30-1—the port 1 on the lower level communication node 30-2—the port 2 on the lower level communication node 30-2—the port 2 on the lower level communication node 30-3. As a processing method for the higher level communication node 20-1 to transmit data addressed to the higher level communication node 20-3, the path management unit 12 determines to instruct the lower level communication node 30-1 to transmit the data addressed to the higher level communication node 20-3 from the port 2. The path management unit 12 transmits, to the higher level communication node 20-1, a processing method indicating instructing the lower level communication node 30-1 to transmit data addressed to the higher level communication node 20-3 from the port 2.

In a case of receiving data from the lower level communication node 30-1 when a failure is occurring in the higher level communication node 20-2, the path management unit 12 determines transmission port information indicating port information according to which the lower level communication node 30-1 transmits the data, based on the destination of the data. For example, when data are transmitted from the higher level communication node 20-1 to the higher level communication node 20-3, as transmission port information for the lower level communication node 30-1 to transmit the data, the path management unit 12 determines to transmit the data from the port 2. The path management unit 12 transmits, to the lower level communication node 30-1, transmission port information indicating transmitting data from the port 2.

The failure monitoring unit 13 monitors failure occurrence status in the network. The failure monitoring unit 13 transmits failure monitoring data for confirming existence of a failure in the network to the higher level communication nodes 20 and the lower level communication nodes 30 through the communication unit 11. For example, the failure monitoring unit 13 determines that a failure is not occurring in the higher level communication nodes 20 and the lower level communication nodes 30 by receiving responses to the failure monitoring data from the higher level communication nodes 20 and the lower level communication nodes. When a response to failure monitoring data is not received from a communication node to which the failure monitoring data are transmitted, the failure monitoring unit 13 determines that a failure is occurring in the communication node. A state in which a failure is determined to occur may be described as a failure is detected.

The failure monitoring unit 13 refers to the network information storage unit 14 and instructs a communication node adjoining a communication node connected to the communication node in which a failure is detected to transmit data received by the communication node to the controller 10. For example, when detecting occurrence of a failure in the higher level communication node 20-2, the failure monitoring unit 13 instructs the lower level communication nodes 30-1 and 30-3 adjoining the lower level communication node 30-2 to transmit data received by the lower level communication nodes 30-1 and 30-3 to the controller 10. The reason for thus coping with the failure state is that, for example, when the lower level communication node 30-2 receives data in a situation in which a failure is occurring in the higher level communication node 20-2, the lower level communication node 30-2 cannot determine a port from which data are transmitted and thus communication is interrupted.

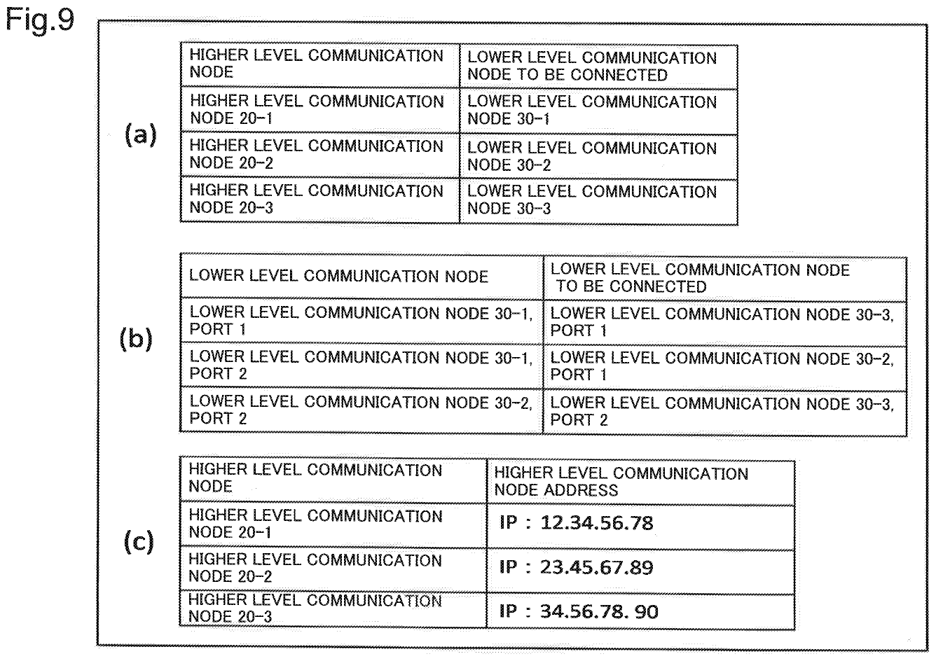

The network information storage unit 14 holds information about the higher level communication nodes 20 and the lower level communication nodes 30. FIG. 9 is an example of information held by the network information storage unit 14.

Table (a) in FIG. 9 is a layer-by-layer communication node reference table held by the network information storage unit 14. The layer-by-layer communication node reference table indicates information about a communication node belonging to each layer and a communication node being connected to the communication node and belonging to another layer. For example, the higher level communication node 20-1 belonging to a higher layer is connected to the lower level communication node 30-1 belonging to a lower layer.

Table (b) in FIG. 9 is port information held by the network information storage unit 14. The port information indicates information about a port on a communication node connected to a port on each communication node. For example, a port on the lower level communication node 30-1 is connected to the port 1 on the lower level communication node 30-3.

Table (c) in FIG. 9 is an address reference table held by the network information storage unit 14. The address reference table indicates information about an address of a higher level communication node 20. For example, an IP address of the higher level communication node 20-1 is 12.34.56.78. While Table (c) in FIG. 9 assumes an address of a higher level communication node 20 to be an IP address, the address is not limited to an IP address and may be, for example, a MAC address, an identification number of the communication node, or a product number of the communication node.

The information held by the network information storage unit 14 is not limited to the layer-by-layer communication node reference table, the port information, and the address reference table. For example, as information about a path determined by the path management unit 12, a processing method and/or transmission port information transmitted to each communication node may be held, or information about a failure occurring in each communication node or at each interface may be held.

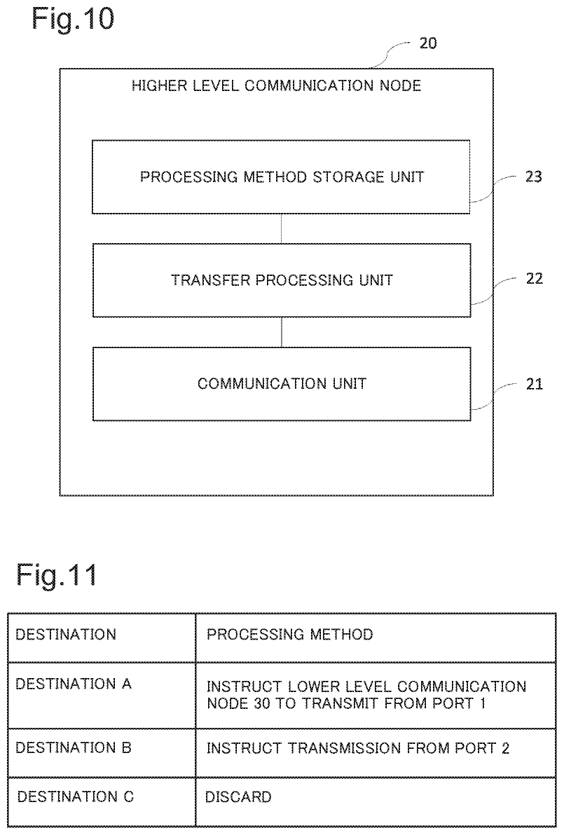

FIG. 10 is a block diagram illustrating a configuration example of a higher level communication node 20 according to the first example embodiment.

The higher level communication node 20 includes a communication unit 21, a transfer processing unit 22, and a processing method storage unit 23.

The transfer processing unit 22 stores a processing method received from the controller 10 through the communication unit 21 into the processing method storage unit 23.

When receiving data from a lower level communication node 30 through the communication unit 21, the transfer processing unit 22 refers to the destination of the data and a destination stored in the processing method storage unit 23, and determines a processing method being a method for processing the data. The transfer processing unit 22 processes the data in accordance with the determined processing method.

The processing method storage unit 23 holds a data processing method used by the higher level communication node 20. FIG. 11 is an example of a processing method held by the processing method storage unit 23.

For example, the transfer processing unit 22 in the higher level communication node 20 receives data the destination of which being a destination A from a lower level communication node 30 through the communication unit 21. The higher level communication node 20 refers to the processing method storage unit 23 and determines to “instruct the lower level communication node 30 to transmit the data from the port 1” as a processing method of the data with the destination A. In accordance with the determined processing method, the transfer processing unit 22 instructs the lower level communication node 30 to transmit the data from the port 1. Specifically, the higher level communication node 20 transmits, to the lower level communication node 30, transmission port information indicating transmitting the data from the port 1.

The processing method storage unit 23 may hold any information that can be identified as a destination. For example, information such as an IP address, a MAC address, an identification number of a communication node, or a product number of a communication node may be held as a destination. A processing method may not only indicate a transmitting port but also indicate, for example, a processing method such as editing or discarding data. Without being limited to use of a destination as a condition for determining a processing method, the processing method storage unit 23 may determine a processing method by use of information such as a type and/or priority of data.

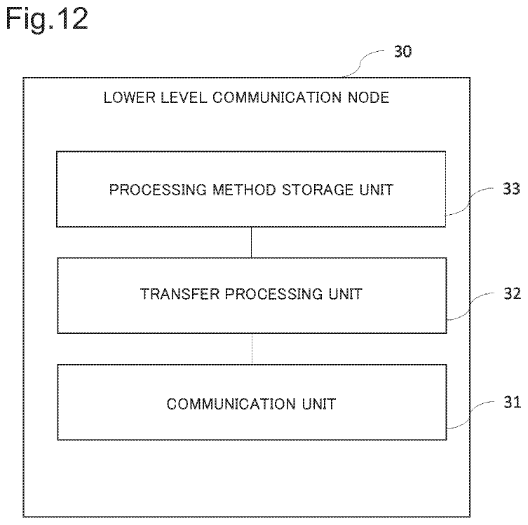

FIG. 12 is a block diagram illustrating a configuration example of a lower level communication node 30 according to the first example embodiment.

The lower level communication node 30 includes a communication unit 31, a transfer processing unit 32, and a processing method storage unit 33.

The transfer processing unit 32 receives data from a higher level communication node 20 through the communication unit 31. The transfer processing unit 32 refers to the processing method storage unit 33 and based on a port from which the data are received, determines transmission port information indicating a port from which the data are transmitted. In accordance with the determined transmission port information, the transfer processing unit 32 transmits the received data from the port.

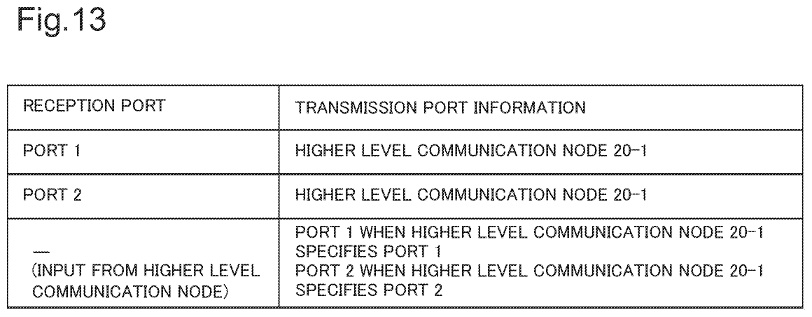

The processing method storage unit 33 holds transmission port information used by the lower level communication node 30. FIG. 13 is an example of a processing method held by the processing method storage unit 33.

For example, when receiving data from the port 1, the transfer processing unit 32 refers to the processing method storage unit 33. The transfer processing unit 32 refers to the receiving port and the transmission port information, and determines to transmit the data received from the port 1 to the higher level communication node 20-1. In accordance with the determined transmission port information, the transfer processing unit 32 transmits the data to the higher level communication node 20-1. For example, the transfer processing unit 32 receives, from the higher level communication node 20-1, transmission port information indicating transmitting data from the port 2. The transfer processing unit 32 refers to the processing method storage unit 33 and determines to transmit data from a port specified by the higher level communication node 20-1. In accordance with the determined transmission port information, the transfer processing unit 32 transmits the data from the port 2.

### Operation of Second Configuration

An operation example according to the first example embodiment of the present invention will be described with reference to FIG. 7 and FIG. 14 to FIG. 17.

Arrows illustrated in FIGS. 7, 14, and 17 indicate an example of a data transfer path being a path for transmitting data from the higher level communication node 20-1 to the higher level communication node 20-3. Numerals described beside lower level communication nodes in FIGS. 7, 14, and 17 denote port numbers. It is assumed in the following description that a higher level communication node 20 and a lower level communication node 30 transmit and receive data by use of a working interface.

FIG. 7 is a diagram illustrating a configuration example of the multilayer network according to the first example embodiment and an example of a data transfer path. The multilayer network in FIG. 7 is in a state in which no failure is occurring in any of the communication nodes.

The higher level communication node 20-1 determines a processing method for transmitting data to the destination. Specifically, as a processing method of data transmitted to the higher level communication node 20-3, the higher level communication node 20-1 determines to instruct the lower level communication node 30-1 to transmit data from the port 2.

The higher level communication node 20-1 transmits the port number determined as transmission port information and data to the lower level communication node 30-1.

The lower level communication node 30-1 refers to the transmission port information for transmitting received data and determines a port from which the data are transmitted. Specifically, the lower level communication node 30-1 determines to transmit the data received from the higher level communication node 20-1 from the port 2 specified by the higher level communication node 20-1. The lower level communication node 30-1 transmits the received data from the port 2.

The lower level communication node 30-2 refers to transmission port information for transmitting received data and determines a port from which the data are transmitted. Specifically, the lower level communication node 30-2 determines to transmit data received from the port 1 to the higher level communication node 20-2. The lower level communication node 30-2 transmits the received data to the higher level communication node 20-2.

The higher level communication node 20-2 receiving data from the lower level communication node 30-2 refers to the received data and determines a processing method for transmitting the data to the higher level communication node 20-3. As a processing method of the data, the higher level communication node 20-2 determines to instruct the lower level communication node 30-2 to transmit data from the port 2.

The higher level communication node 20-2 transmits the port number determined as transmission port information and the data to the lower level communication node 30-2.

The lower level communication node 30-2 transmits the data received from the higher level communication node 20-2 from the port 2 specified by the higher level communication node 20-2.

The lower level communication node 30-3 transmits data received from the port 2 to the higher level communication node 20-3.

The higher level communication node 20-3 receiving data from the lower level communication node 30-3 refers to the received data and when confirming that the own node is the destination, ends data transfer.

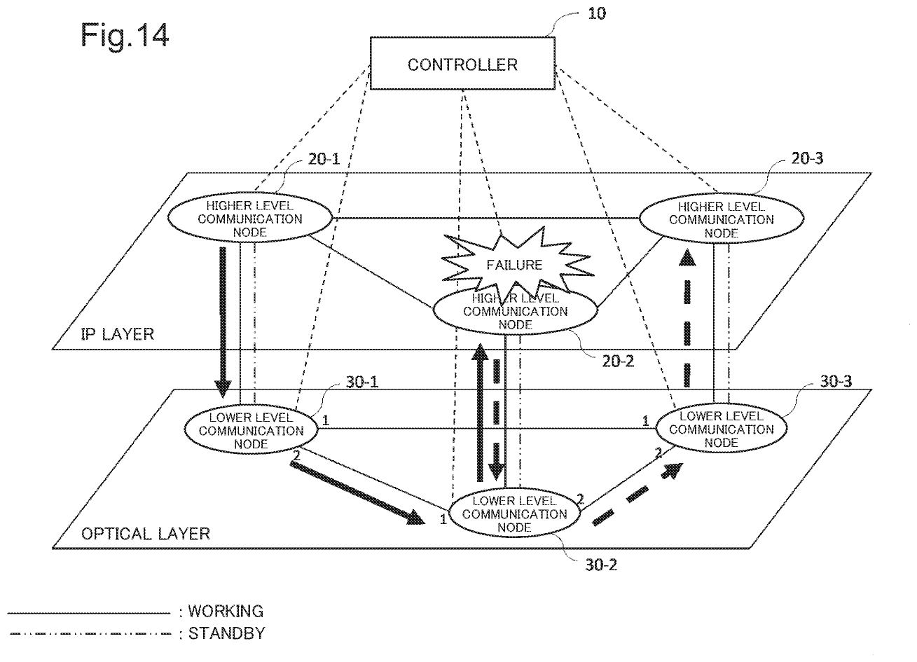

FIG. 14 is a diagram illustrating an example of a state in which a failure has occurred in the higher level communication node 20-2 in the multilayer network illustrated in FIG. 7.

When a failure occurs in the higher level communication node 20-2, the lower level communication node 30-2 cannot receive data from the higher level communication node 20-2. Consequently, the lower level communication node 30-2 cannot determine a port from which data are transmitted and thus cannot transmit data to the lower level communication node 30-3 and the higher level communication node 20-3.

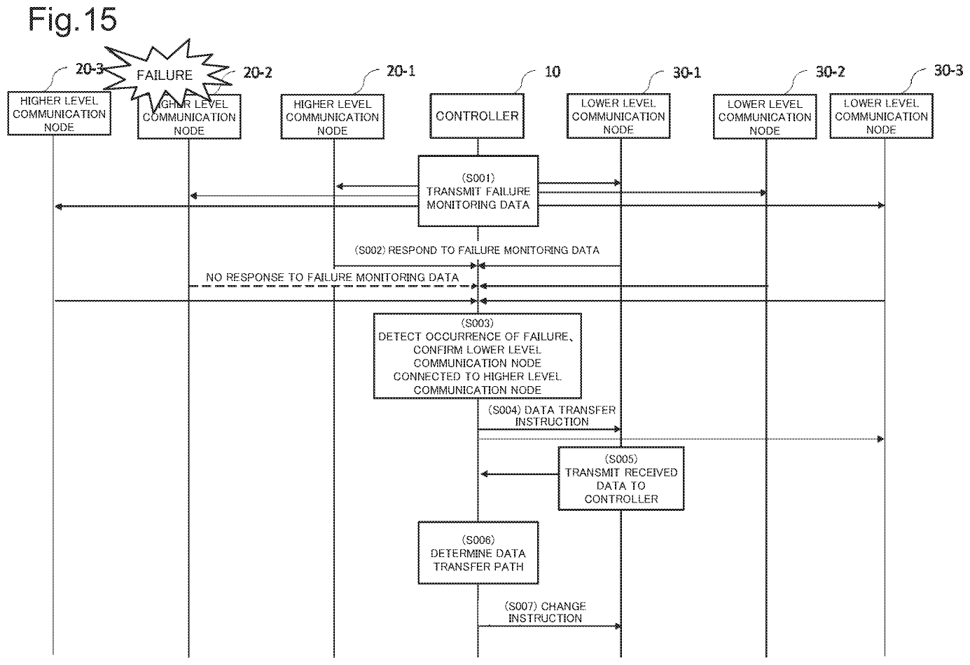

FIG. 15 is a sequence diagram illustrating an operation example of coping with the failure occurring in the multilayer network illustrated in FIG. 14.

The failure monitoring unit 13 in the controller 10 transmits failure monitoring data for confirming existence of a failure in the network to the higher level communication nodes 20 and the lower level communication nodes 30 (S001).

A communication node receiving the failure monitoring data transmits data responding to the failure monitoring data to the controller 10 (S002). The higher level communication node 20-1 and the higher level communication node 20-3 out of the higher level communication nodes 20 belonging to the higher layer transmit data responding to the failure monitoring data to the controller 10. The lower level communication node 30-1, the lower level communication node 30-2, and the lower level communication node 30-3 out of the lower level communication nodes 30 belonging to the lower layer transmit data responding to the failure monitoring data to the controller 10.

Since data responding to the failure monitoring data are not received from the higher level communication node 20-2, the failure monitoring unit 13 in the controller 10 determines that a failure is occurring in the higher level communication node 20-2. The failure monitoring unit 13 in the controller 10 confirms that a lower level communication node 30 connected to the higher level communication node 20-2 in which the failure is detected is the lower level communication node 30-2 (S003).

The failure monitoring unit 13 in the controller 10 instructs the lower level communication nodes 30-1 and 30-3 adjoining the lower level communication node 30-2 to transmit data received by the lower level communication node 30-1 and the lower level communication node 30-3 to the controller 10 (S004).

An operation in a case of the lower level communication node 30-1 receiving data addressed to the higher level communication node 20-3 will be described as an example in the following description.

The transfer processing unit 32 in the lower level communication node 30-1 transmits received data to the controller 10 (S005).

When receiving the data from the lower level communication node 30-1, the path management unit 12 in the controller 10 confirms that the destination of the data is the higher level communication node 20-3 from the destination address of the data. The path management unit 12 in the controller 10 determines to transmit the data in an order of the lower level communication node 30-1—lower level communication node 30-3 as a path for transmitting the data to the higher level communication node 20-3 (S006). In order to transmit data on the determined path, the path management unit 12 determines ports from which the data are transmitted. The path management unit 12 determines to transmit the data by using ports in an order of the port 1 on the lower level communication node 30-1—the port 1 on the lower level communication node 30-3.

For the lower level communication node 30-1, the path management unit 12 in the controller 10 determines transmission port information for transmitting data to the lower level communication node 30-3.

The path management unit 12 in the controller 10 instructs the lower level communication node 30-1 to change transmission port information held in the processing method storage unit 33 to the determined transmission port information (S007). Specifically, the path management unit 12 in the controller 10 transmits the determined transmission port information to the lower level communication node 30-1.

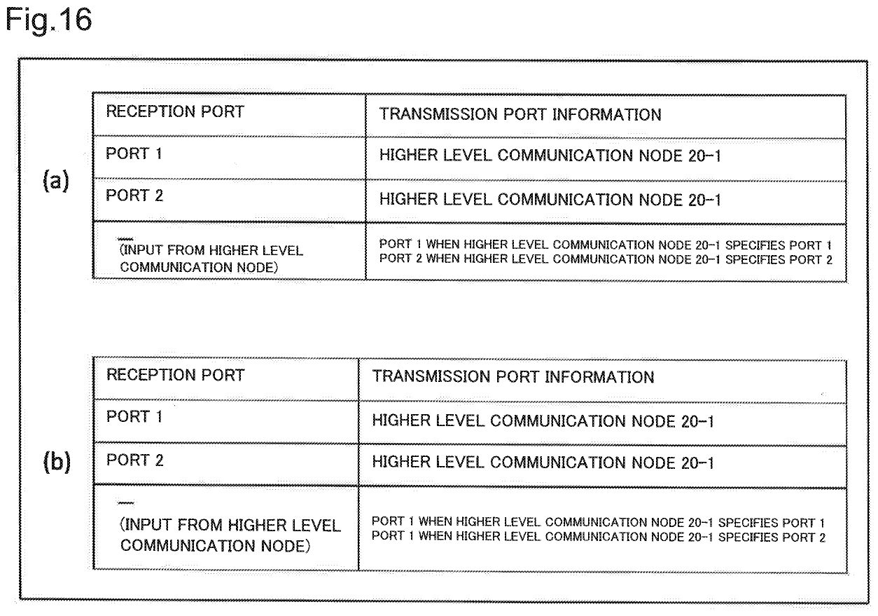

FIG. 16 is an example of transmission port information held by the processing method storage unit 33 in the lower level communication node 30-1 before and after the occurrence of the failure in the higher level communication node 20-2.

Table (a) in FIG. 16 is an example of transmission port information held by the processing method storage unit 33 in the lower level communication node 30-1 before the occurrence of the failure in the higher level communication node 20-2. For example, when the higher level communication node 20-1 specifies data received from the higher level communication node 20-1 to be transmitted from the port 2, the lower level communication node 30-1 transmits the data from the port 2.

Table (b) in FIG. 16 is an example of transmission port information held by the processing method storage unit 33 in the lower level communication node 30-1 after the controller 10 instructs the lower level communication node 30-1 to change transmission port information in S007 described in FIG. 15. In order to transmit data in an order of the lower level communication node 30-1—the lower level communication node 30-3, the path management unit 12 in the controller 10 instructs the lower level communication node 30-1 to change transmission port information “the port 2 when the higher level communication node 20-1 specifies the port 2” held by the processing method storage unit 33 to “the port 1 when the higher level communication node 20-1 specifies the port 2.”Specifically, the path management unit 12 transmits the transmission port information “the port 1 when the higher level communication node 20-1 specifies the port 2” to the lower level communication node 30-1.

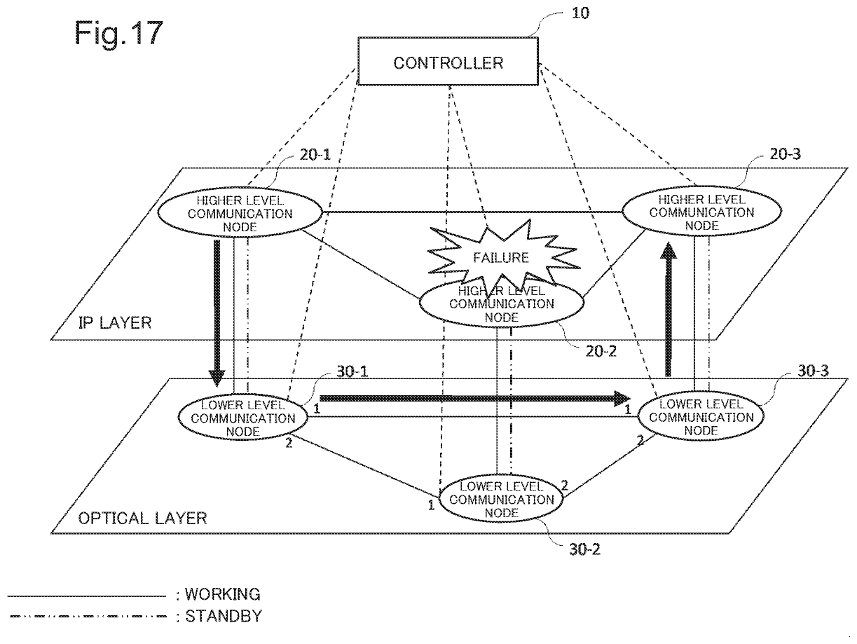

FIG. 17 is a diagram illustrating an example of a state in which the failure occurring in the multilayer network illustrated in FIG. 14 is coped with. FIG. 17 illustrates an example of a data transfer path after the controller 10 instructs the lower level communication node 30-1 to change transmission port information in S007 described in FIG. 15.

In accordance with the instruction from the controller 10, the lower level communication node 30-1 transmits data to the lower level communication node 30-3 without performing data transmission to the lower level communication node 30-2.

From the above, even when a failure occurs in a higher level communication node 20, the multilayer network in the second configuration can provide a highly fault-tolerant system continuing communication in the multilayer network by changing transmission port information held by a lower level communication node 30.

### Third Configuration

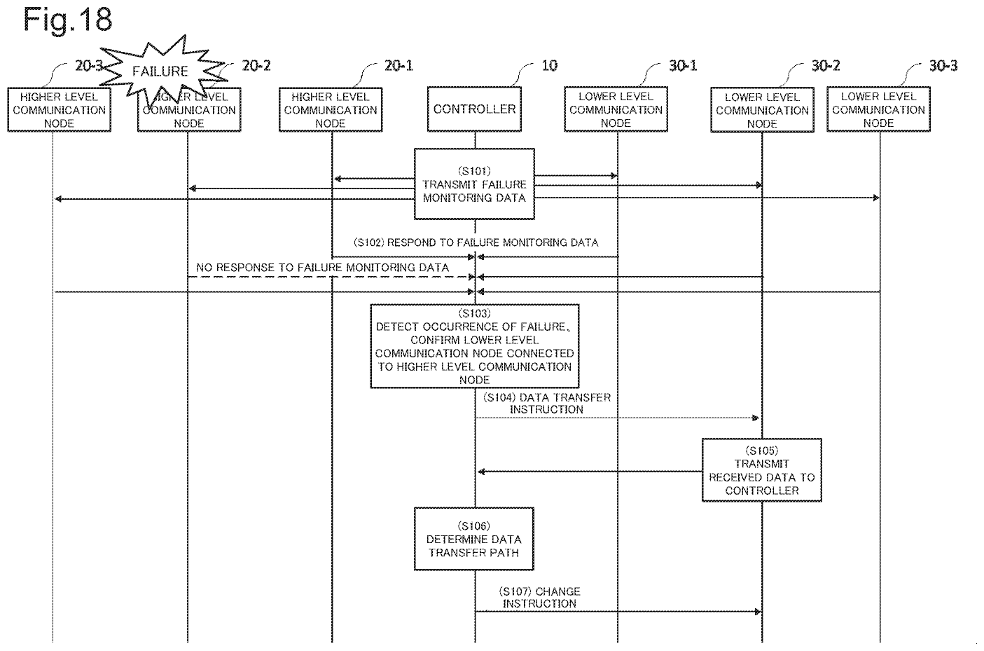

In the multilayer network illustrated in FIG. 14 to FIG. 17, the controller 10 determines a path not using the lower level communication node 30-2 connected to the higher level communication node 20-2 as a means for coping with the failure occurring in the higher level communication node 20-2. Further, the controller 10 transmits, to the lower level communication node 30-1, transmission port information for transmitting data on the path. However, a means for coping with the failure occurring in the higher level communication node 20-2 is not limited to the above. Another reactive operation performed when a failure occurs, according to the first example embodiment of the present invention, will be described by use of FIG. 18 to FIG. 20.

A multilayer network in a third configuration has a configuration similar to that of the multilayer network in the second configuration illustrated in FIG. 14.

### Operation of Third Configuration

FIG. 18 is a sequence diagram illustrating another operation example of coping with the failure occurring in the multilayer network illustrated in FIG. 14.

S101 to S103 in FIG. 18 are similar to S001 to S003 illustrated in FIG. 15, and therefore detailed description is omitted.

The failure monitoring unit 13 in the controller 10 instructs the lower level communication node 30-2 to transmit data received by the lower level communication node 30-2 to the controller 10 (S104).

The transfer processing unit 32 in the lower level communication node 30-2 transmits the received data to the controller 10 (S105).

When receiving the data from the lower level communication node 30-2, the path management unit 12 in the controller 10 confirms that the destination of the data is the higher level communication node 20-3 from the destination address of the data. The path management unit 12 in the controller 10 determines to transmit the data in an order of the lower level communication node 30-1—the lower level communication node 30-2—the lower level communication node 30-3 as a path for transmitting the data to the higher level communication node 20-3 (S106).

In order to transmit the data to the lower level communication node 30-3 on the path determined based on the destination of the data, the path management unit 12 in the controller 10 determines transmission port information for the lower level communication node 30-2. In order to transmit the data on the determined path, the path management unit 12 in the controller 10 determines to use ports in an order of the port 2 on the lower level communication node 30-1—the port 1 on the lower level communication node 30-2—the port 2 on the lower level communication node 30-2—port 2 on the lower level communication node 30-3. The path management unit 12 determines to instruct the lower level communication node 30-2 to transmit the data from the port 2, as transmission port information.

The path management unit 12 in the controller 10 instructs the lower level communication node 30-2 to change transmission port information held in the processing method storage unit 33 to the determined transmission port information (S107). Specifically, the path management unit 12 in the controller 10 transmits the determined transmission port information to the lower level communication node 30-2.

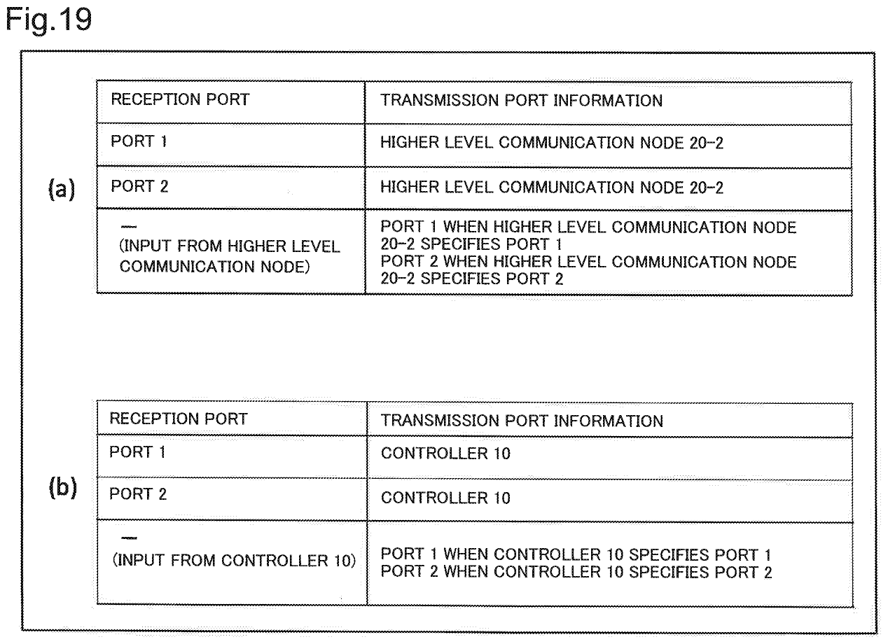

FIG. 19 is an example of a processing method held by the processing method storage unit 33 in the lower level communication node 30-2 before and after the occurrence of the failure in the higher level communication node 20-2 illustrated in FIG. 18.

FIG. 19 is an example of a processing method held by the processing method storage unit 33 in the lower level communication node 30-2 before and after the occurrence of the failure in the higher level communication node 20-2.

Table (a) in FIG. 19 is an example of transmission port information held by the processing method storage unit 33 in the lower level communication node 30-2 before the occurrence of the failure in the higher level communication node 20-2. For example, when the higher level communication node 20-2 specifies data received from the higher level communication node 20-2 to be transmitted from the port 2 on the lower level communication node 30-2, the lower level communication node 30-2 transmits the data from the port 2.

Table (b) in FIG. 19 is an example of transmission port information held by the processing method storage unit 33 in the lower level communication node 30-2 after the controller 10 instructs the lower level communication node 30-2 to change transmission port information in S107 described in FIG. 18. In order to grasp data received by the lower level communication node 30-2, the path management unit 12 in the controller 10 instructs the lower level communication node 30-2 to follow transmission port information for transmitting the received data to the controller 10. Further, the controller 10 instructs the lower level communication node 30-2 to change transmission port information “the port 1 when the higher level communication node 20-2 specifies the port 1” held by the processing method storage unit 33 to “the port 1 when the controller 10 specifies the port 1.” Specifically, the path management unit 12 transmits the transmission port information “the port 1 when the controller 10 specifies the port 1” to the lower level communication node 30-2.

The controller 10 instructs the lower level communication node 30-2 to change transmission port information “the port 2 when the higher level communication node 20-2 specifies the port 2” held by the processing method storage unit 33 to “the port 2 when the controller 10 specifies the port 2.” Specifically, the path management unit 12 transmits the transmission port information “the port 2 when the controller 10 specifies the port 2” to the lower level communication node 30-2.

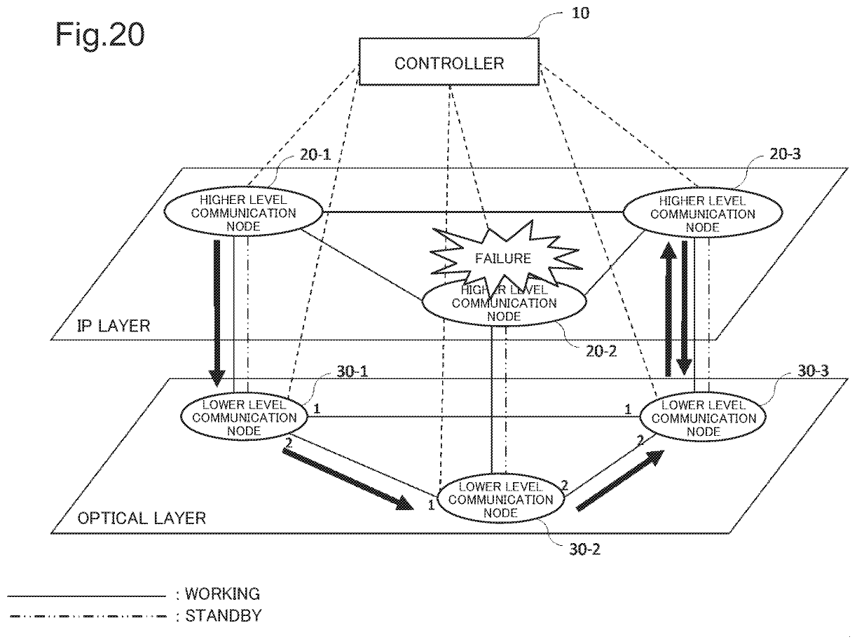

FIG. 20 is a diagram illustrating another state in which the failure occurring in the multilayer network illustrated in FIG. 18 is coped with. FIG. 20 illustrates an example of a data transfer path after the controller 10 instructs the lower level communication node 30-2 to change transmission port information in S107 described in FIG. 18.

The lower level communication node 30-2 transmits data received from the lower level communication node 30-1 to the controller 10 instead of the higher level communication node 20-2. The controller 10 determines a transfer path of the data received from the lower level communication node 30-2. The controller 10 instructs the lower level communication node 30-2 to change transmission port information of data.

From the above, even when a failure occurs in a higher level communication node 20, the multilayer network in the third configuration can provide a highly fault-tolerant system continuing communication in the multilayer network by changing transmission port information held by a lower level communication node 30.

Furthermore, lower level communication nodes 30 can transfer data without changing a path used between the lower level communication nodes 30 before and after the occurrence of the failure in the higher level communication node 20 in the multilayer network in the third configuration. Consequently, data can be transferred without consideration of a load and congestion at lower level communication nodes caused by changing a data transfer path, in the multilayer network in the third configuration.

While the example of transmission port information held by the processing method storage unit 33 illustrated in FIG. 19 illustrates transmission port information about which the lower level communication node 30-2 makes an inquiry to the controller 10 every time data are received after the occurrence of a failure in the higher level communication node 20-2, transmission port information instructed by the controller 10 is not limited to the above. For example, the controller 10 may instruct the processing method storage unit 33 in the lower level communication node 30-2 to change “transmission to the higher level communication node 20-2” to “transmission from the port 2” with regard to data received from the port 1.

A method of detecting a failure by the failure monitoring unit 13 in the controller 10 is not limited to existence of responses to failure monitoring data from higher level communication nodes 20 and lower level communication nodes 30. For example, the failure monitoring unit 13 may periodically receive data indicating that a failure is not occurring from each communication node. For example, the failure monitoring unit 13 may receive data indicating detection of a failure in an adjoining communication node from higher level communication nodes 20 and lower level communication nodes 30.

Further, a failure detected by the failure monitoring unit 13 is not limited to a failure in a communication node. For example, the failure monitoring unit 13 may detect an interface failure by receiving information about a failure occurring at an interface from a communication node.

Additionally, while the multilayer network according to the first example embodiment is described with an IP layer and an optical layer, the multilayer network is not limited to the configuration using an IP layer and an optical layer. For example, the multilayer network may have a configuration using a MAC layer using a MAC address, and an optical layer.

### Second Example Embodiment

### First Configuration

A second example embodiment of the present invention will be described in detail with reference to drawings. A technology in the second example embodiment is applicable to any of the first example embodiment and an example embodiment to be described later. While a case of two layers being an IP layer and an optical layer has been described in the first example embodiment, a case of a three-layered multilayer network further including an electrical layer will be described in the second example embodiment.

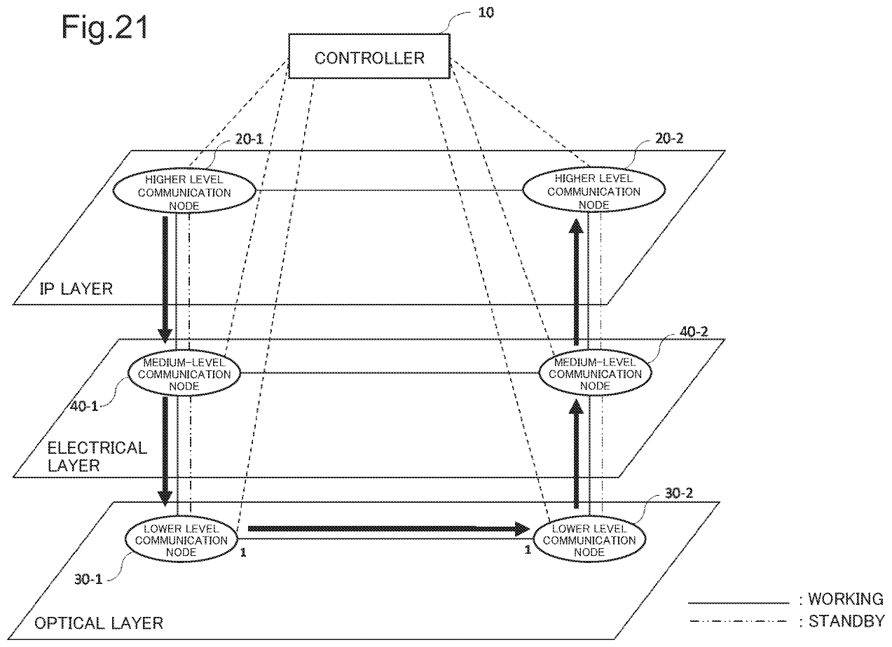

FIG. 21 is a diagram illustrating a configuration example of a multilayer network according to the second example embodiment.

The multilayer network according to the second example embodiment includes a controller 10, a lower level communication node 30-1 and a lower level communication node 30-2 that belong to an optical layer, a medium-level communication node 40-1 and a medium-level communication node 40-2 that belong to an electrical layer, and a higher level communication node 20-1 and a higher level communication node 20-2 that belong to an IP layer.

Configuration examples of the higher level communication node 20 and the lower level communication node 30 according to the second example embodiment are similar to those of the higher level communication node 20 and the lower level communication node 30 according to the first example embodiment illustrated in FIG. 4, and therefore detailed description is omitted.

A medium-level communication node 40 belonging to the electrical layer performs signal conversion of data exchanged between layers. For example, a medium-level communication node 40 converts data received from a higher level communication node 20 into an optical signal. The medium-level communication node 40 transmits the optical signal acquired by the conversion to a lower level communication node 30. For example, a medium-level communication node 40 converts an optical signal received from a lower level communication node 30 into an electrical signal. The medium-level communication node 40 transmits the electrical signal acquired by the conversion to a higher level communication node 20.

For example, medium-level communication nodes 40 mutually transmit data by an electrical signal in which a plurality of digital signals are multiplexed [optical channel data unit (ODU) cross-connect].

In the following description, data represented by an electrical signal may be simply described as data.

A higher level communication node 20 belonging to the IP layer and a medium-level communication node 40 belonging to the electrical layer, and a medium-level communication node 40 belonging to the electrical layer and a lower level communication node 30 belonging to the optical layer are connected to one another through two or more interfaces. For example, the interface may use 1 Gigabit Ethernet (GbE), 10 GbE, or 100 GbE. Further, for example, the interface may use a serial interface such as a universal serial bus (USB) or Fibre Channel, or a parallel interface such as an Industrial Standard Architecture bus (ISA) or a peripheral component interconnect (PCI). However, a standard used by the interface is not limited to GbE, USB, ISA, or PCI.

Two types of roles being working and standby are defined for the interface. The working and standby interfaces are similar to the working and standby interfaces according to the first example embodiment, and therefore detailed description is omitted.

### Operation of First Configuration

Examples of an operation performed before a failure occurs and a reactive operation performed when a failure occurs, according to the second example embodiment of the present invention, will be described by use of FIG. 21 to FIG. 23.

Arrows illustrated in FIG. 21 indicate an example of a data transfer path being a path for transmitting data from the higher level communication node 20-1 to the higher level communication node 20-2. Numerals described beside lower level communication nodes in FIG. 21 to FIG. 23 denote port numbers.

The higher level communication node 20-1 determines a data processing method for transmitting data to the destination. Specifically, as a processing method of data transmitted to the higher level communication node 20-2, the higher level communication node 20-1 determines to instruct the lower level communication node 30-1 to transmit the data from a port 1.

The higher level communication node 20-1 transmits, to the lower level communication node 30-1, transmission port information indicating a port from which the lower level communication node 30-1 transmits data. Specifically, the higher level communication node 20-1 transmits the port number determined as transmission port information and data to the medium-level communication node 40-1. At this time, the higher level communication node 20-1 transmits the data to the medium-level communication node 40-1 by use of a working interface.

The medium-level communication node 40-1 converts the data received from the higher level communication node 20-1 into an optical signal. The medium-level communication node 40-1 transmits the data converted into the optical signal and the port number to the lower level communication node 30-1. At this time, the medium-level communication node 40-1 transmits the data converted into the optical signal and the port number to the lower level communication node 30-1 by use of a working interface.

The lower level communication node 30-1 transmits the received data from a port with the specified number. Specifically, the lower level communication node 30-1 transmits the received data from the port 1.

The lower level communication node 30-2 transmits received data to the medium-level communication node 40-2.

The medium-level communication node 40-2 converts the data received from the lower level communication node 30-2 into an electrical signal. The medium-level communication node 40-2 transmits the data converted into the electrical signal to the higher level communication node 20-2.

The higher level communication node 20-2 receiving data from the medium-level communication node 40-2 refers to the received data and when confirming that the own node is the destination, ends data transfer.

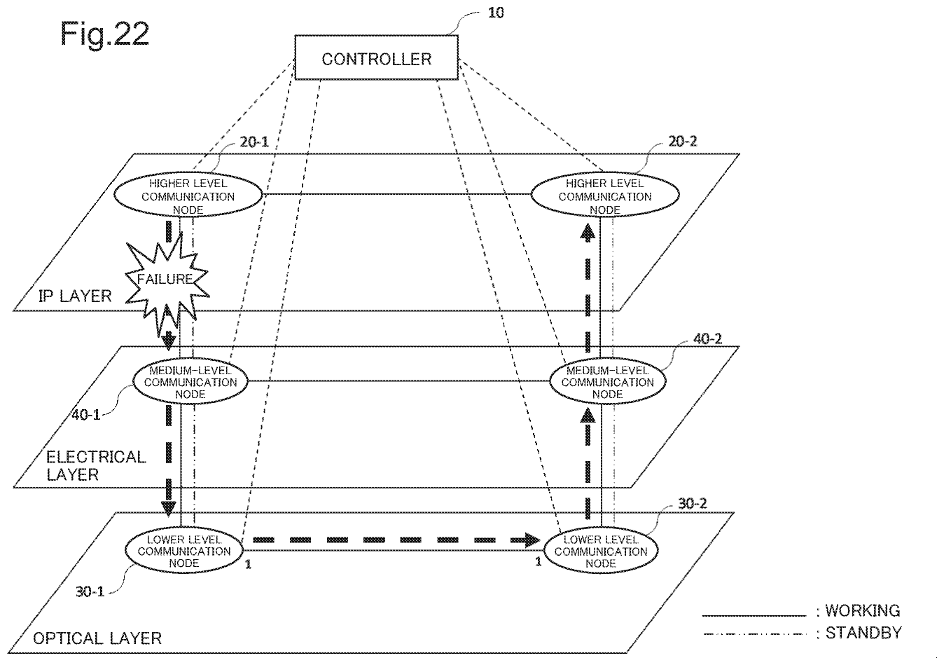

FIG. 22 is a diagram illustrating an example of a state in which a failure has occurred at an interface between a higher level communication node 20 and a medium-level communication node 40 in the multilayer network illustrated in FIG. 21. For example, a failure occurring at an interface refers to a state in which a port on a communication node cannot be used or a state in which a line connecting between communication nodes is disconnected.

When a failure occurs at an interface between the higher level communication node 20-1 and the medium-level communication node 40-1, the higher level communication node 20-1 cannot transmit the data to the medium-level communication node 40-1. Consequently, the data are also not transmitted from the medium-level communication node 40-1 to the lower level communication node 30-1, from the lower level communication node 30-1 to the lower level communication node 30-2, from the lower level communication node 30-2 to the medium-level communication node 40-2, and from the medium-level communication node 40-2 to the higher level communication node 20-2. Accordingly, even though the higher level communication node 20-1, the higher level communication node 20-2, the medium-level communication node 40-1, the medium-level communication node 40-2, the lower level communication node 30-1, and the lower level communication node 30-2 are in a state of being capable of processing data, the higher level communication node 20-1 cannot transmit data to the higher level communication node 20-2.

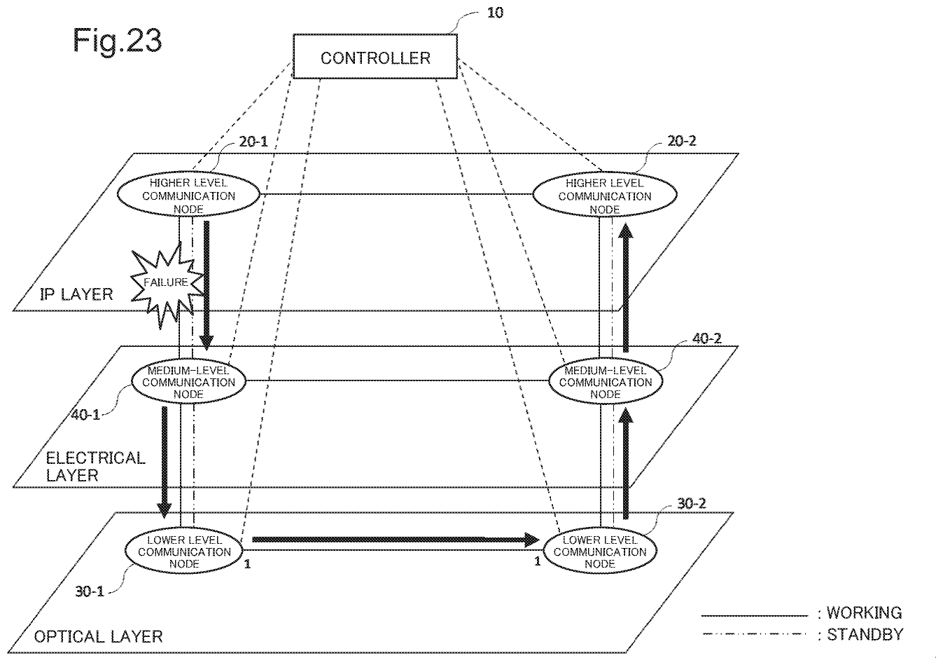

FIG. 23 is a diagram illustrating an example of a state in which the failure occurring in the multilayer network illustrated in FIG. 22 is coped with.

The controller 10 detects occurrence of a failure at the interface between the higher level communication node 20-1 and the medium-level communication node 40-1. Specifically, the controller 10 receives a notification that a failure is occurring at the interface from the higher level communication node 20-1. For example, the controller 10 may detect a failure by receiving a notification that a failure is occurring at the interface from the medium-level communication node 40-1.

The controller 10 instructs the higher level communication node 20-1 and the medium-level communication node 40-1 to switch an interface to be used. Specifically, the controller 10 instructs the higher level communication node 20-1 and the medium-level communication node 40-1 to switch the interface used between the higher level communication node 20-1 and the medium-level communication node 40-1 from the working interface to a standby interface. By using the standby interface in place of the working interface where the failure has occurred, the higher level communication node 20-1 can transmit data to the medium-level communication node 40-1.

The controller 10 may instruct the higher level communication node 20-1 to switch back from the standby interface to the working interface after the failure occurring at the working interface is cleared. For example, the controller 10 may instruct switching to the working interface, with occurrence of a failure at the standby interface as a trigger.

While a case of a failure occurring at an interface between a higher level communication node 20 and a medium-level communication node 40 has been described in FIG. 22, the operation of the first configuration is not limited to be implemented in this case. For example, when a failure occurs at an interface between the medium-level communication node 40 and the lower level communication node 30-1, the failure is coped with by a similar procedure. Further, for example, when failures occur at both of an interface between a higher level communication node 20 and a medium-level communication node 40, and an interface between a medium-level communication node 40 and a lower level communication node 30, the failures are coped with by a similar procedure.

As described above, when detecting occurrence of a failure at a working interface, the controller 10 instructs a higher level communication node 20 and a medium-level communication node 40 to use a standby interface, in the first configuration. Consequently, even when a failure occurs at an interface between communication nodes in different layers, a highly fault-tolerant system continuing communication in the multilayer network can be provided.

### Second Configuration

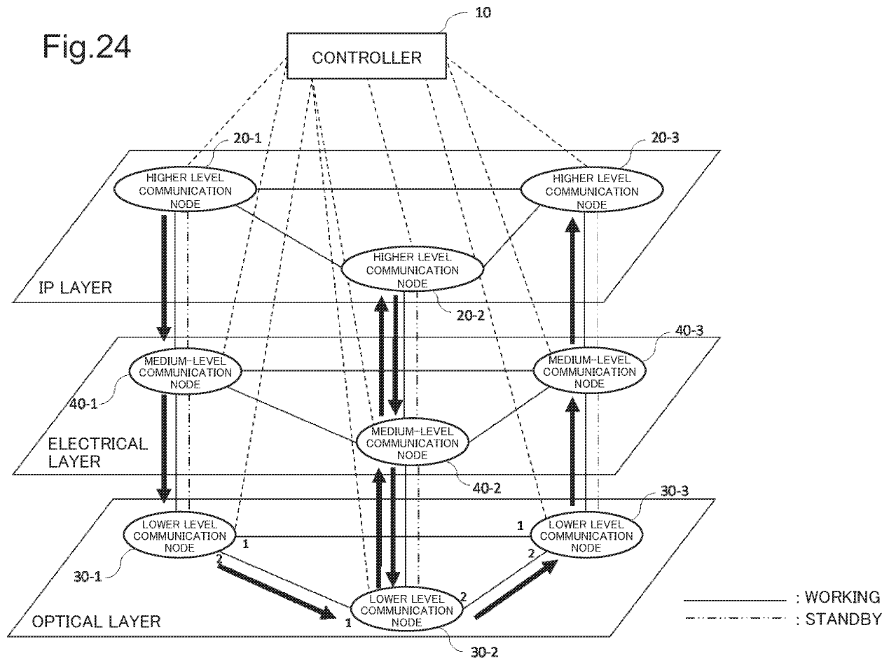

FIG. 24 is a diagram illustrating another configuration example of the multilayer network according to the second example embodiment. FIG. 24 is acquired by adding a higher level communication node 20-3, a medium-level communication node 40-3, and a lower level communication node 30-3 to the configuration of the multilayer network illustrated in FIG. 21.

The multilayer network according to the second example embodiment includes a controller 10, a lower level communication node 30-1, a lower level communication node 30-2, and the lower level communication node 30-3 that belong to an optical layer, a medium-level communication node 40-1, a medium-level communication node 40-2, and the medium-level communication node 40-3 that belong to an electrical layer, and a higher level communication node 20-1, a higher level communication node 20-2, and the higher level communication node 20-3 that belong to an IP layer. A higher level communication node 20 and a medium-level communication node 40, and a medium-level communication node 40 and a lower level communication node 30 are connected through a plurality of interfaces.

Arrows illustrated in FIG. 24 indicate an example of a data transfer path being a path for transmitting data from the higher level communication node 20-1 to the higher level communication node 20-3. Numerals described beside lower level communication nodes in FIG. 24 denote port numbers.

The controller 10 is connected to the higher level communication nodes 20, the medium-level communication nodes 40, and the lower level communication nodes 30. The controller 10 performs setting for transmitting data to another communication node on each of the higher level communication nodes 20, the medium-level communication nodes 40, and the lower level communication nodes 30.

A configuration of the controller 10 is similar to that of the controller 10 according to the first example embodiment illustrated in FIG. 8, and therefore detailed description is omitted.

Configurations of the higher level communication node 20 and the lower level communication node 30 are also similar to those of the higher level communication node 20 and the lower level communication node 30 according to the first example embodiment illustrated in FIG. 10 and FIG. 12, and therefore detailed description is omitted.

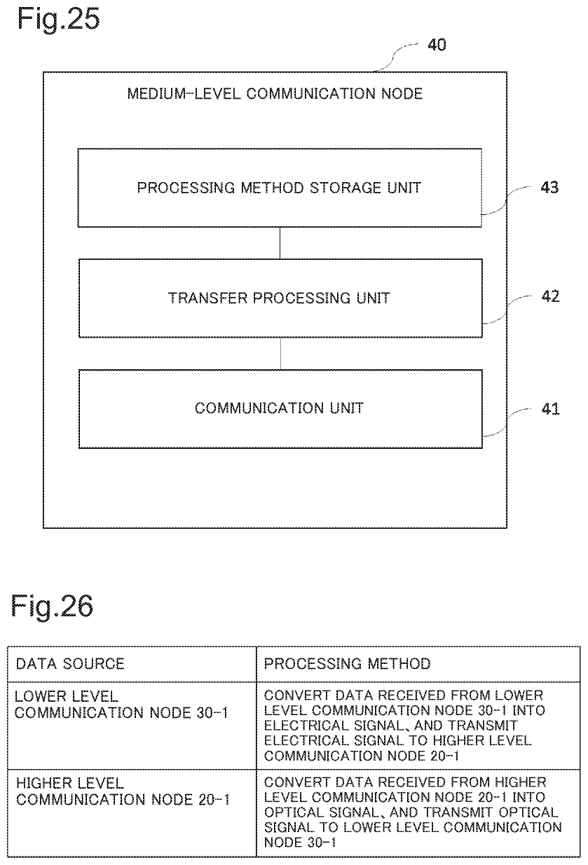

FIG. 25 is a block diagram illustrating a configuration example of a medium-level communication node 40 according to the second example embodiment.

The medium-level communication node 40 includes a communication unit 41, a transfer processing unit 42, and a processing method storage unit 43.

The transfer processing unit 42 stores a data processing method received from the controller 10 through the communication unit 41 into the processing method storage unit 43.

When receiving data from a lower level communication node 30 through the communication unit 41, the transfer processing unit 42 refers to the source of the data and a source described in the processing method storage unit 43, and determines a processing method being a method for processing data. In accordance with the determined processing method, the transfer processing unit 42 processes the data. When receiving data from a higher level communication node 20 through the communication unit 41, the transfer processing unit 42 refers to the source of the data and a source described in the processing method storage unit 43, and determines a processing method being a method for processing data. In accordance with the determined processing method, the transfer processing unit 42 processes the data.

The processing method storage unit 43 holds a processing method of data used by the medium-level communication node 40. FIG. 26 is an example of a processing method held by the processing method storage unit 43 in the medium-level communication node 40-1.

For example, the transfer processing unit 42 in the medium-level communication node 40-1 receives data from the higher level communication node 20-1 through the communication unit 41. The transfer processing unit 42 refers to the processing method storage unit 43 and, as a data processing method of data the source of which is the higher level communication node 20-1, determines to “convert data received from the higher level communication node 20-1 into an optical signal and transmit the converted signal to the lower level communication node 30-1.” In accordance with the determined processing method, the transfer processing unit 42 converts the received data into an optical signal. The transfer processing unit 42 transmits the data converted into the optical signal to the lower level communication node 30-1.

The transfer processing unit 42 is not limited to use a source of data as a condition for determining a processing method. For example, a processing method may be determined with an interface through which data are received or a wavelength of an electrical signal as a condition.

### Operation of Second Configuration

An operation example according to the second example embodiment of the present invention will be described with reference to FIG. 24 and FIG. 27 to FIG. 30.

Arrows illustrated in FIGS. 24, 27, and 30 indicate an example of a data transfer path being a path for transmitting data from the higher level communication node 20-1 to the higher level communication node 20-3. Numerals described beside lower level communication nodes in FIGS. 24, 27, and 30 denote port numbers. It is assumed in the following description that a higher level communication node 20 and a medium-level communication node 40, and a medium-level communication node 40 and a lower level communication node 30 transmit and receive data by use of working interfaces.

FIG. 24 is a diagram illustrating a configuration example of the multilayer network according to the second example embodiment and an example of a data transfer path. The multilayer network in FIG. 24 is in a state in which no failure is occurring in any of the communication nodes.

The higher level communication node 20-1 determines a processing method for transmitting data to the destination. Specifically, the higher level communication node 20-1 determines to instruct the lower level communication node 30-1 to transmit data from a port 2 as a processing method of transmitting data to the higher level communication node 20-3.

The higher level communication node 20-1 transmits the port number determined as transmission port information and the data to the medium-level communication node 40-1.

As a processing method of the data received from the higher level communication node 20-1, the medium-level communication node 40-1 determines to convert the data into an optical signal and transmit the optical signal to the lower level communication node 30-1. The medium-level communication node 40-1 converts the received data into an optical signal. The medium-level communication node 40-1 transmits the data converted into the optical signal and the port number to the lower level communication node 30-1.

The lower level communication node 30-1 refers to the transmission port information for transmitting received data and determines to transmit data received from the medium-level communication node 40-1 from a port with the number specified by the higher level communication node 20-1. The lower level communication node 30-1 transmits the received data from the port 2 specified by the higher level communication node 20-1.

The lower level communication node 30-2 refers to transmission port information for transmitting received data and determines to transmit data received from the port 1 to the medium-level communication node 40-2. The lower level communication node 30-2 transmits the received data to the medium-level communication node 40-2.

As a processing method of the data received from the lower level communication node 30-2, the medium-level communication node 40-2 determines to convert the data into an electrical signal and transmit the electrical signal to the higher level communication node 20-2. The medium-level communication node 40-2 converts the received data into an electrical signal. The medium-level communication node 40-2 transmits the data converted into the electrical signal to the higher level communication node 20-2.

As a processing method of transmitting the data to the higher level communication node 20-3, the higher level communication node 20-2 receiving the data from the medium-level communication node 40-2 determines to instruct the lower level communication node 30-2 to transmit the data from the port 2.

The higher level communication node 20-2 transmits the port number determined as transmission port information and the data to the medium-level communication node 40-2.

As a processing method of the data received from the higher level communication node 20-2, the medium-level communication node 40-2 determines to convert the data into an optical signal and transmit the optical signal to the lower level communication node 30-2. The medium-level communication node 40-2 converts the received data into an optical signal. The medium-level communication node 40-2 transmits the data converted into the optical signal and the port number to the lower level communication node 30-2.

The lower level communication node 30-2 refers to the transmission port information for transmitting received data and determines to transmit the data received from the medium-level communication node 40-2 from the port 2 specified by the higher level communication node 20-2. The lower level communication node 30-2 transmits the received data from the port 2 specified by the higher level communication node 20-2.

The lower level communication node 30-3 refers to transmission port information for transmitting received data and determines to transmit the data received from the port 2 to the medium-level communication node 40-3. The lower level communication node 30-3 transmits the received data to the medium-level communication node 40-3.

As a processing method of the data received from the lower level communication node 30-3, the medium-level communication node 40-3 determines to convert the data into an electrical signal and transmit the electrical signal to the higher level communication node 20-3. The medium-level communication node 40-3 converts the data received from the lower level communication node 30-3 into an electrical signal. The medium-level communication node 40-3 transmits the data converted into the electrical signal to the higher level communication node 20-3.

The higher level communication node 20-3 receiving data from the medium-level communication node 40-3 refers to the received data and when confirming that the own node is the destination, ends data transfer.

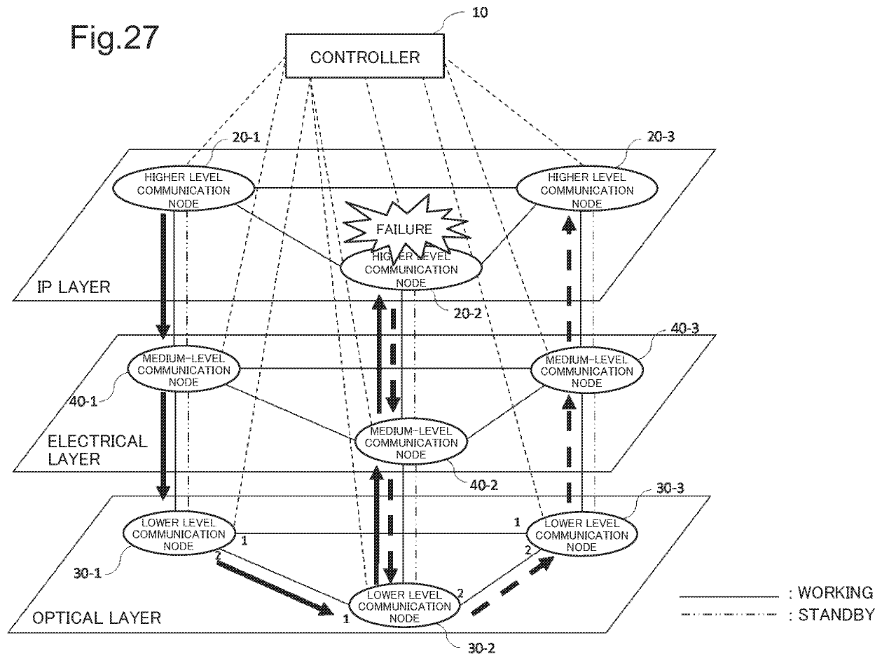

FIG. 27 is a diagram illustrating an example of a failure occurring in the higher level communication node 20-2 in the multilayer network illustrated in FIG. 24.

When a failure occurs in the higher level communication node 20-2, the lower level communication node 30-2 cannot receive data from the higher level communication node 20-2 through the medium-level communication node 40-2. Consequently, the lower level communication node 30-2 cannot determine a port from which data are transmitted and cannot transmit data to the lower level communication node 30-3, the medium-level communication node 40-3, and the higher level communication node 20-3.

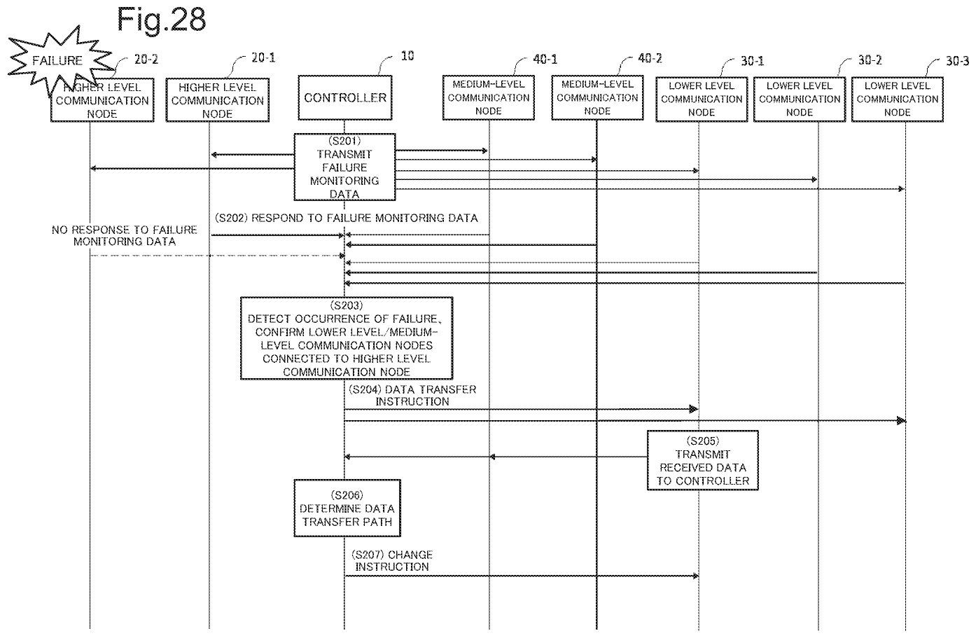

FIG. 28 is a sequence diagram illustrating an operation example of coping with the failure occurring in the multilayer network illustrated in FIG. 27.

S201 to S205 in FIG. 28 are similar to S001 to S005 illustrated in FIG. 15, and therefore detailed description is omitted.

When receiving data from the lower level communication node 30-1 through the medium-level communication node 40-1, the path management unit 12 in the controller 10 confirms that the destination of the data is the higher level communication node 20-3 from the destination address of the data. The path management unit 12 in the controller 10 determines to transmit the data in an order of the lower level communication node 30-1—the lower level communication node 30-3 as a path for transmitting the data to the higher level communication node 20-3 (S206). In order to transmit the data on the determined path, the path management unit 12 determines ports from which the data are transmitted, based on the determined path. The path management unit 12 determines to transmit the data by use of ports in an order of the port 1 on the lower level communication node 30-1—the port 1 on the lower level communication node 30-3.

For the lower level communication node 30-1, the path management unit 12 in the controller 10 determines transmission port information for transmitting data to the lower level communication node 30-3.

The path management unit 12 in the controller 10 instructs the lower level communication node 30-1 to change transmission port information held in the processing method storage unit 33 to the determined transmission port information (S207). Specifically, the path management unit 12 in the controller 10 transmits the determined transmission port information to the lower level communication node 30-1.

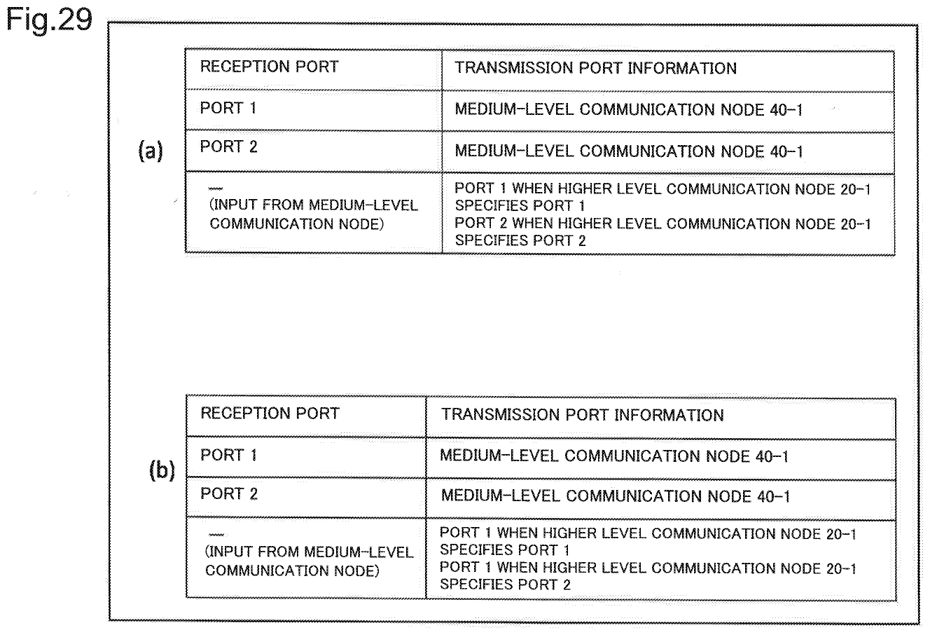

FIG. 29 is an example of transmission port information held by the processing method storage unit 33 in the lower level communication node 30-1 before and after the occurrence of the failure in the higher level communication node 20-2.

Table (a) in FIG. 29 is an example of transmission port information held by the processing method storage unit 33 in the lower level communication node 30-1 before the occurrence of the failure in the higher level communication node 20-2. For example, when the higher level communication node 20-1 specifies transmission of data from the port 2, the lower level communication node 30-1 transmits data received from the higher level communication node 20-1 from the port 2.

Table (b) in FIG. 29 is an example of transmission port information held by the processing method storage unit 33 in the lower level communication node 30-1 after the controller 10 instructs the lower level communication node 30-1 to change transmission port information in S207 described in FIG. 28. In order to transmit data in an order of the lower level communication node 30-1—the lower level communication node 30-3, the path management unit 12 instructs the lower level communication node 30-1 to change a processing method “the port 2 when the higher level communication node 20-1 specifies the port 2” held by the processing method storage unit 33 to “the port 1 when the higher level communication node 20-1 specifies the port 2.” Specifically, the path management unit 12 transmits the transmission port information “the port 1 when the higher level communication node 20-1 specifies the port 2” to the lower level communication node 30-1.

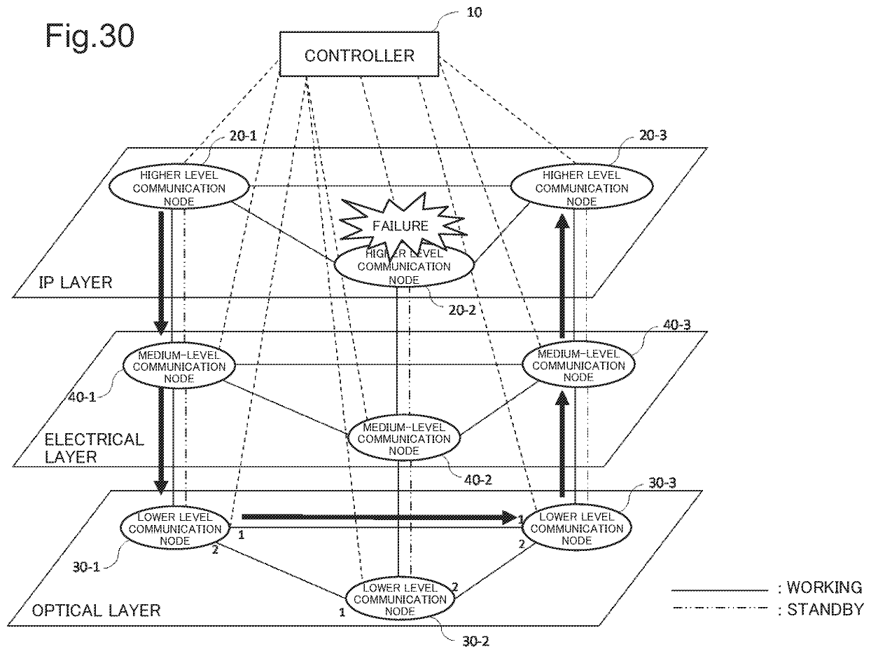

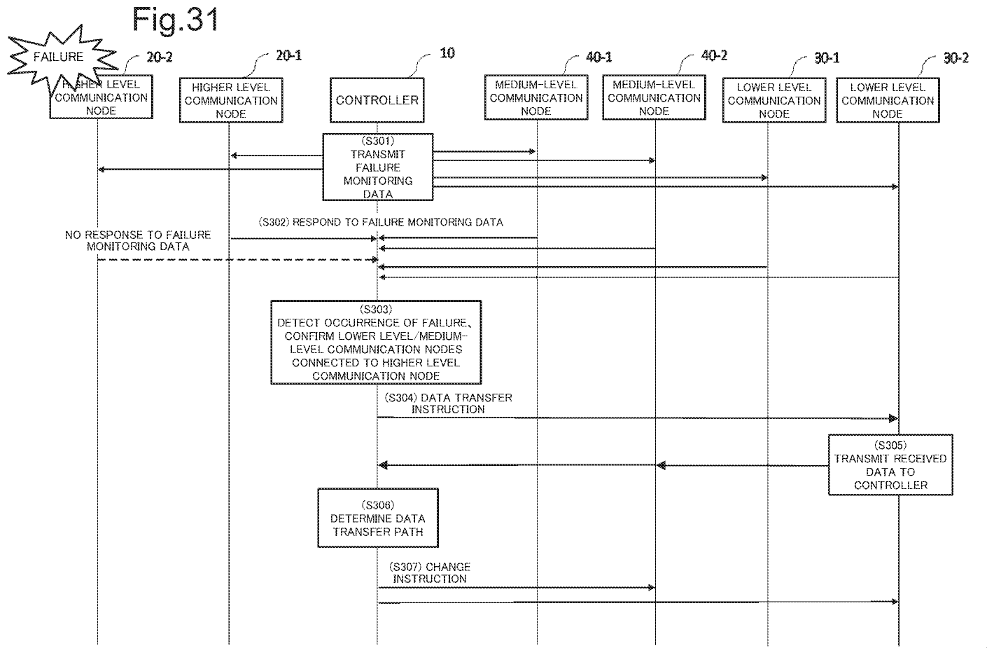

FIG. 30 is a diagram illustrating an example of a state in which the failure occurring in the multilayer network illustrated in FIG. 27 is coped with. FIG. 30 illustrates an example of a data transfer path after the controller 10 instructs the lower level communication node 30-1 to change transmission port information in S207 described in FIG. 28.

In accordance with the instruction from the controller 10, the lower level communication node 30-1 transmits data to the lower level communication node 30-3 without performing data transmission to the lower level communication node 30-2. From the above, even when a failure occurs in a higher level communication node 20, the multilayer network in the second configuration can provide a highly fault-tolerant system continuing communication in the multilayer network by changing transmission port information held by a lower level communication node 30.

### Third Configuration

In the multilayer network illustrated in FIG. 27 to FIG. 30, the controller 10 determines a path not using the lower level communication node 30-2 connected to the higher level communication node 20-2 as a means for coping with the failure occurring in the higher level communication node 20-2. Further, the controller 10 transmits, to the lower level communication node 30-1, transmission port information for transmitting data on the path. However, a means for coping with the failure occurring in the higher level communication node 20-2 is not limited to the above. Another reactive operation performed when a failure occurs, according to the second example embodiment of the present invention, will be described by use of FIG. 31 to FIG. 35.

A multilayer network in a third configuration has a configuration similar to that of the multilayer network in the second configuration illustrated in FIG. 27.

### Operation of Third Configuration

FIG. 31 is a sequence diagram illustrating another operation example of coping with the failure occurring in the multilayer network illustrated in FIG. 27.

S301 to 5303 in FIG. 31 are similar to S001 to S003 illustrated in FIGS. 15, S101 to S103 illustrated in FIGS. 18, and S201 to S203 illustrated in FIG. 28, and therefore detailed description is omitted.

The failure monitoring unit 13 in the controller 10 instructs the lower level communication node 30-2 to transmit data received by the lower level communication node 30-2 to the controller 10 (S304).

The transfer processing unit 32 in the lower level communication node 30-2 transmits the received data to the controller 10 (S305).

When receiving the data from the lower level communication node 30-2, the path management unit 12 in the controller 10 confirms that the destination of the data is the higher level communication node 20-3 from the destination address of the data. The path management unit 12 in the controller 10 determines to transmit the data in an order of the lower level communication node 30-1—the lower level communication node 30-2—the lower level communication node 30-3 as a path for transmitting the data to the higher level communication node 20-3 (S306).

In order to transmit the data on the path determined based on the destination of the data, the path management unit 12 determines ports from which the data are transmitted. In order to transmit data on the determined path, the path management unit 12 in the controller 10 determines to use ports in an order of the port 2 on the lower level communication node 30-1—the port 1 on the lower level communication node 30-2—the port 2 on the lower level communication node 30-2—the port 2 on the lower level communication node 30-3. The path management unit 12 determines to instruct the lower level communication node 30-2 to transmit the data from the port 2 as transmission port information.

For the lower level communication node 30-2, the path management unit 12 in the controller 10 determines transmission port information for transmitting the data to the lower level communication node 30-3.

The path management unit 12 in the controller 10 instructs the lower level communication node 30-2 to change transmission port information held in the processing method storage unit 33 to the determined transmission port information (S307). Specifically, the path management unit 12 in the controller 10 transmits the determined transmission port information to the lower level communication node 30-2.

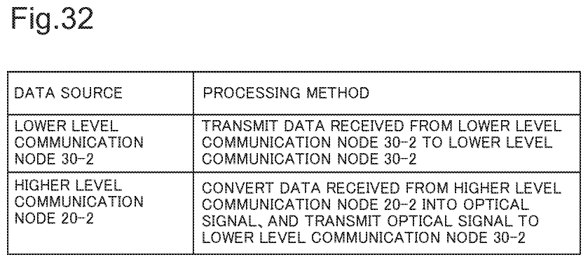

FIG. 32 is an example of a processing method held by the processing method storage unit 43 in the medium-level communication node 40-2 after the controller 10 instructs the medium-level communication node 40-2 to change the processing method in S307 described in FIG. 31.

The path management unit 12 in the controller 10 gives an instruction to change a processing method “convert data received from the lower level communication node 30-2 into an electrical signal and transmit the electrical signal to the higher level communication node 20-2” held by the processing method storage unit 43 to “transmit data received from the lower level communication node 30-2 to the lower level communication node 30-2.” Specifically, the path management unit 12 transmits the transmission port information “transmit data received from the lower level communication node 30-2 to the lower level communication node 30-2” to the medium-level communication node 40-2.

The path management unit 12 in the controller 10 may change or delete a processing method “convert data received from the higher level communication node 20-2 into an optical signal and transmit the optical signal to the lower level communication node 30-2.” The reason is that there is no situation in which the medium-level communication node 40-2 receives data from the higher level communication node 20-2 in which the failure is occurring.

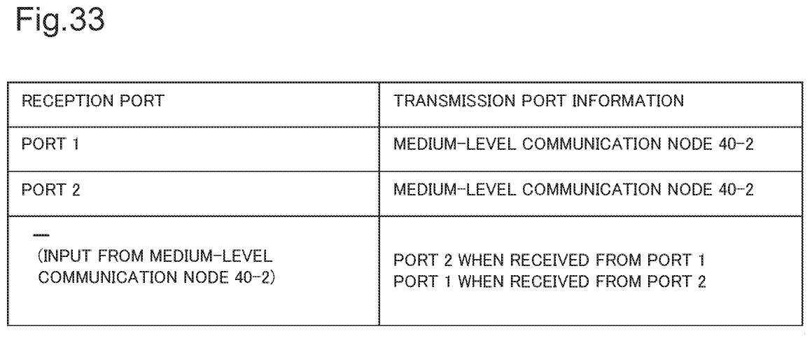

FIG. 33 is an example of transmission port information held by the processing method storage unit 33 in the lower level communication node 30-2 after the controller 10 instructs the lower level communication node 30-2 to change transmission port information in S307 described in FIG. 31.

The path management unit 12 in the controller 10 changes transmission port information “the port 1 when the higher level communication node 20-2 specifies the port 1” held by the processing method storage unit 33 to “the port 2 when received from the port 1.” Specifically, the path management unit 12 transmits the transmission port information “the port 2 when received from the port 1” to the lower level communication node 30-2. Further, the path management unit 12 in the controller 10 changes transmission port information “the port 2 when the higher level communication node 20-2 specifies the port 2” held by the processing method storage unit 33 to “the port 1 when received from the port 2.” Specifically, the path management unit 12 transmits the transmission port information “the port 1 when received from the port 2” to the lower level communication node 30-2.

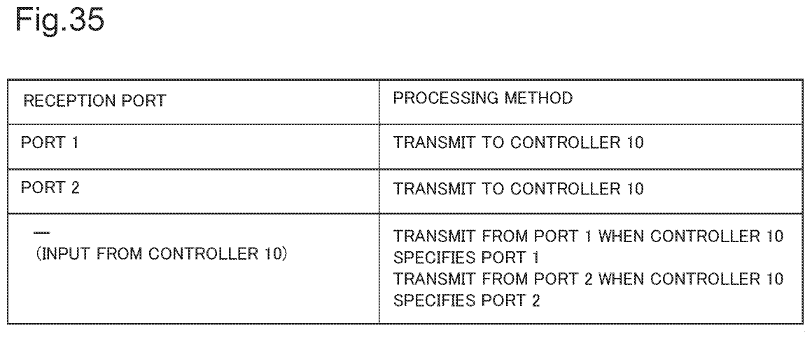

While the controller 10 gives an instruction to follow transmission port information for selecting a transmission port, based on a port from which the lower level communication node 30-2 receives data, in the example of transmission port information held by the processing method storage unit 33 illustrated in FIG. 33, transmission port information to be followed in accordance with an instruction given by the controller 10 is not limited to the above. For example, the controller 10 may give an instruction to follow transmission port information causing the lower level communication node 30-2 to make an inquiry to the controller 10 every time data are received, as illustrated in FIG. 35.

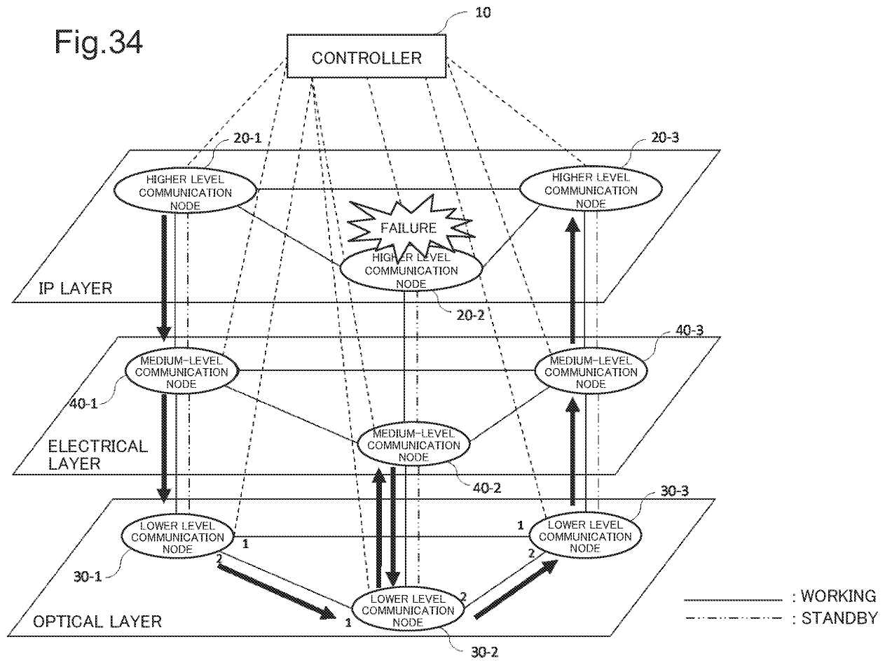

FIG. 34 is a diagram illustrating another state in which the failure occurring in the multilayer network illustrated in FIG. 27 is coped with. FIG. 34 illustrates an example of a data transfer path after the controller 10 instructs the lower level communication node 30-2 to change the processing method in S307 described in FIG. 31.

In accordance with the instruction from the controller 10, the medium-level communication node 40-2 transmits data received from the lower level communication node 30-2 to the lower level communication node 30-2. In other words, the medium-level communication node 40-2 returns the data received from the lower level communication node 30-2 to the lower level communication node 30-2. In accordance with the instruction from the controller 10, the lower level communication node 30-2 transmits, from the port 2, data received from the port 1.

From the above, even when a failure occurs in a higher level communication node 20, the multilayer network in the third configuration can provide a highly fault-tolerant system continuing communication in the multilayer network by changing transmission port information held by a lower level communication node 30.

Furthermore, lower level communication nodes 30 can transmit data without changing a path used between the lower level communication nodes 30 before and after the occurrence of the failure in the higher level communication node 20 in the multilayer network in the third configuration. Consequently, data can be transmitted without consideration of a load and congestion at lower level communication nodes 30 caused by changing a data transfer path, in the multilayer network in the third configuration.

### Fourth Configuration

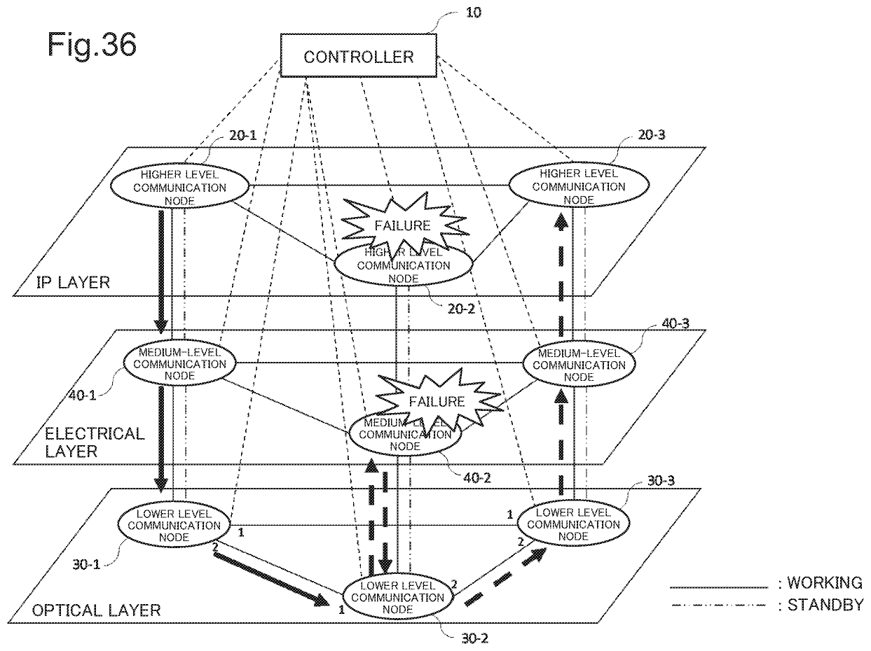

In the multilayer network illustrated in FIG. 32 to FIG. 34, the controller 10 instructs the medium-level communication node 40-2 and the lower level communication node 30-2 to follow a processing method and transmission port information as a means for coping with the failure occurring in the higher level communication node 20-2. However, a means for coping with the failure occurring in the higher level communication node 20-2 is not limited to the above. Another reactive operation performed when a failure occurs, according to the second example embodiment of the present invention, will be described by use of FIG. 36 to FIG. 39.

FIG. 36 is a diagram illustrating an example of a state in which a failure has occurred in the medium-level communication node 40-2 in the multilayer network illustrated in FIG. 27.

When a failure occurs in the medium-level communication node 40-2, the lower level communication node 30-2 cannot receive data from the higher level communication node 20-2 through the medium-level communication node 40-2. For example, even when the means for coping with the failure occurring in the higher level communication node 20-2 illustrated in FIG. 32 to FIG. 34 is implemented, the lower level communication node 30-2 cannot receive data from the medium-level communication node 40-2. Consequently, the lower level communication node 30-2 cannot determine a port from which data are transmitted and cannot transmit data to the lower level communication node 30-3, the medium-level communication node 40-3, and the higher level communication node 20-3.

### Operation of Fourth Configuration

The controller 10 receives data received by the lower level communication node 30-2 from the lower level communication node 30-2 by an operation similar to that in S301 to S305 in FIG. 31.

When receiving the data from the lower level communication node 30-2, the path management unit 12 in the controller 10 confirms that the destination of the data is the higher level communication node 20-3 from the destination address of the data. The path management unit 12 in the controller 10 determines to transmit the data in an order of the lower level communication node 30-1—the lower level communication node 30-2—the lower level communication node 30-3 as a path for transmitting the data to the higher level communication node 20-3.

In order to transmit the data on the determined path, the path management unit 12 in the controller 10 determines ports from which the data are transmitted, based on the determined path. In order to transmit the data on the determined path, the path management unit 12 in the controller 10 determines to use ports in an order of the port 2 on the lower level communication node 30-1—the port 1 on the lower level communication node 30-2—the port 2 on the lower level communication node 30-2—the port 2 on the lower level communication node 30-3. For the lower level communication node 30-2, the path management unit 12 determines transmission port information for transmitting the data to the lower level communication node 30-3. The path management unit 12 in the controller 10 instructs the lower level communication node 30-2 to change transmission port information. Specifically, the path management unit 12 in the controller 10 transmits the determined transmission port information to the lower level communication node 30-2.

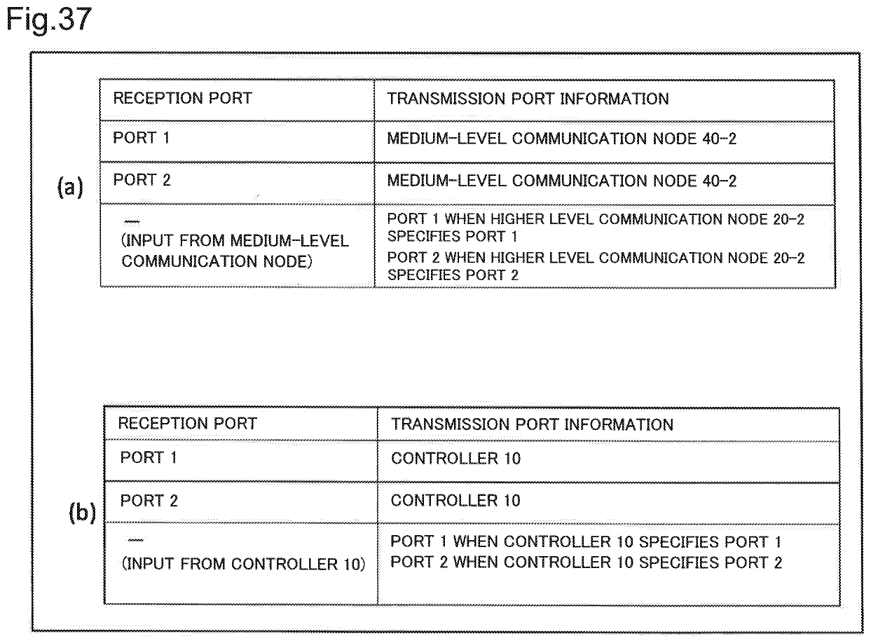

FIG. 37 is an example of transmission port information held by the processing method storage unit 33 in the lower level communication node 30-2 before and after occurrence of failures in the higher level communication node 20-2 and the medium-level communication node 40-2.

Table (a) in FIG. 37 is an example of transmission port information held by the processing method storage unit 33 in the lower level communication node 30-2 before the occurrence of the failure in the higher level communication node 20-2. For example, when the higher level communication node 20-1 specifies transmission of data from the port 2, the lower level communication node 30-2 transmits data received from the higher level communication node 20-1 from the port 2.

Table (b) in FIG. 37 is an example of transmission port information held by the processing method storage unit 33 in the lower level communication node 30-2 after the controller 10 instructs the lower level communication node 30-2 to change transmission port information. In order to grasp data received by the lower level communication node 30-2, the path management unit 12 in the controller 10 instructs the lower level communication node 30-2 to transmit received data to the controller 10. Further, the controller 10 instructs the lower level communication node 30-2 to change transmission port information “the port 1 when the higher level communication node 20-2 specifies the port 1” held by the processing method storage unit 33 to “the port 1 when the controller 10 specifies the port 1.” Specifically, the path management unit 12 transmits the transmission port information “the port 1 when the controller 10 specifies the port 1” to the lower level communication node 30-2. The controller 10 instructs the lower level communication node 30-2 to change transmission port information “the port 2 when the higher level communication node 20-2 specifies the port 2” held by the processing method storage unit 33 to “the port 2 when the controller 10 specifies the port 2.” Specifically, the path management unit 12 transmits the transmission port information “the port 2 when the controller 10 specifies the port 2” to the lower level communication node 30-2.

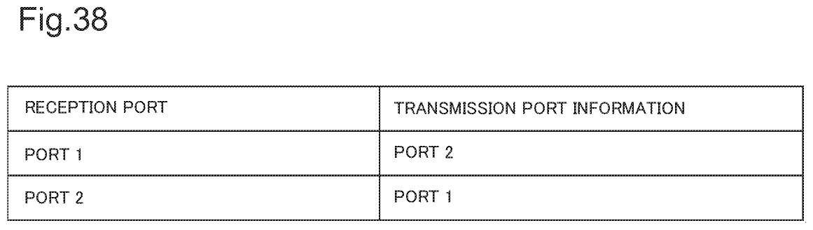

While the example of transmission port information held by the processing method storage unit 33 illustrated in Table (b) in FIG. 37 gives an instruction to follow transmission port information causing the lower level communication node 30-2 to make an inquiry to the controller 10 every time data are received, transmission port information instructed by the controller 10 to follow is not limited to the above. For example, the controller 10 may give an instruction to follow transmission port information causing the lower level communication node 30-2 to select a transmission port, based on a port receiving data, as illustrated in FIG. 38.

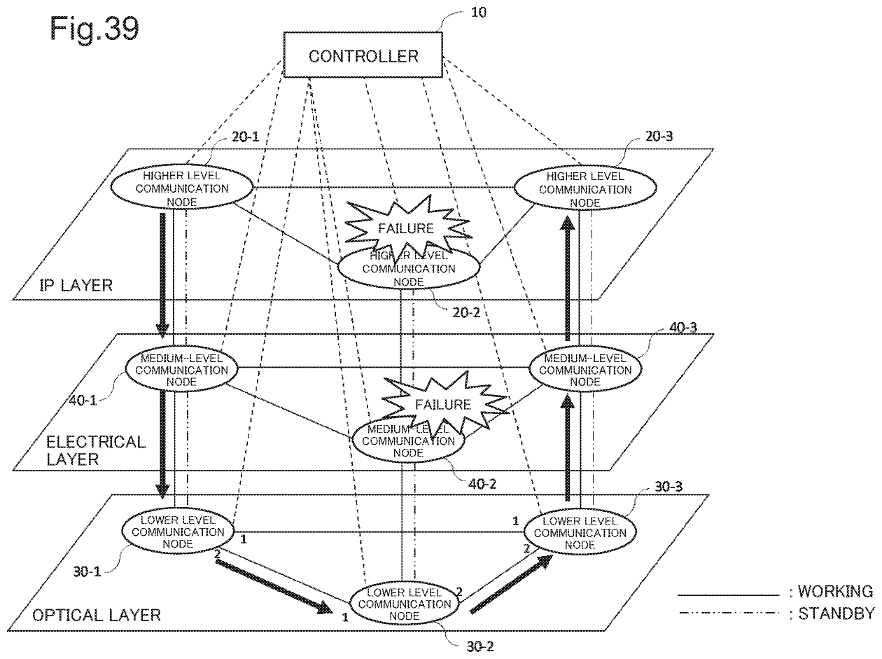

FIG. 39 is a diagram illustrating an example of a state in which the failures occurring in the multilayer network illustrated in FIG. 36 are coped with. FIG. 39 illustrates an example of a data transfer path after the controller 10 instructs the lower level communication node 30-2 to change transmission port information.

The lower level communication node 30-2 transmits data received from the lower level communication node 30-1 to the controller 10 instead of the medium-level communication node 40-2. The controller 10 determines a transfer path of the data received from the lower level communication node 30-2. The controller 10 instructs the lower level communication node 30-2 to follow transmission port information of data.

From the above, even when failures occur in a higher level communication node 20 and a medium-level communication node 40, the multilayer network in the fourth configuration can provide a highly fault-tolerant system continuing communication in the multilayer network by changing a processing method held by a lower level communication node 30.

With regard to each component in the controller, the higher level communication node, the medium-level communication node, and the lower level communication node according to the example embodiments of the present invention, a central processing unit (CPU) or a micro-processing unit (MPU), a memory, and the like may execute software (program) providing the components in FIGS. 2, 3, 8, 10, 12, and 25. The software (program) may be executed by any combination of hardware of any computer described above and software, the computer including a storage device storing the program and a communication interface. FIGS. 2, 3, 8, 10, 12, and 25 illustrate logical-function-based blocks instead of hardware-based configurations.

The controller, the higher level communication node, the medium-level communication node, and the lower level communication node may acquire software (program) providing the functions of the aforementioned example embodiments through, for example, various types of storage media such as a compact disc recordable (CD-R), or a network. A program acquired by the controller, the higher level communication node, the medium-level communication node, and the lower level communication node, and a storage medium storing the program constitute the present invention. The software (program), and a computer, CPUs or MPUs, or the like in the controller, the higher level communication node, the medium-level communication node, and the lower level communication node may be previously stored in, for example, predetermined storage units included in the controller, the higher level communication node, the medium-level communication node, and the lower level communication node. Each of the computers, the CPUs or the MPUs, or the like in the controller, the higher level communication node, the medium-level communication node, and the lower level communication node may read a program code of the acquired software (program) and execute the code.

The present invention is not limited to each of the aforementioned example embodiments. The present invention may be implemented based on modification of, substitution of, and/or adjustment to each example embodiment. Further, the present invention may be implemented in any combination of the example embodiments. In other words, the present invention includes various modifications and changes that may be made based on the entire disclosure and the technological concept of the description. Further, the present invention is also applicable to a technical field of a software-defined network (SDN).

The whole or part of the example embodiments disclosed above can be described as, but not limited to, the following supplementary notes.

### Supplementary Note 1

A control device comprising a means for:

transmitting a processing method of data based on a destination of the data to a second communication device transmitting, in a second layer higher than a first layer, transmission port information indicating a port from which the data are transmitted, to a first communication device transmitting the data in the first layer; and,

when detecting occurrence of a failure in the second communication device, transmitting the transmission port information determined based on a destination of the data to the first communication device.

### Supplementary Note 2

The control device according to Supplementary Note 1, wherein

the processing method is processing for transmitting the data through the first communication device other than the first communication device connected to the second communication device in which the failure has occurred, out of a plurality of the first communication devices, and

the control device transmits the transmission port information to the first communication device other than the first communication device connected to the second communication device in which the failure has occurred.

### Supplementary Note 3

The control device according to Supplementary Note 1, wherein

the processing method is the transmission port information for the first communication device connected to the second communication device in which the failure has occurred, and

the control device transmits the transmission port information to the first communication device connected to the second communication device in which the failure has occurred.

### Supplementary Note 4

The control device according to any one of Supplementary Notes 1 to 3, wherein

a communication line connecting the first communication device and the second communication device is connected through a working interface and one or more standby interfaces, and,

when a failure occurs at the working interface, the control device instructs the first communication device and the second communication device that use the working interface to use the standby interface.

### Supplementary Note 5

The control device according to any one of Supplementary Notes 1 to 4, wherein

the first layer is an optical layer, and the second layer is an IP layer.

### Supplementary Note 6

The control device according to any one of claims 1 to 5, wherein,

when occurrence of a failure is detected in at least one of the second communication devices,

a third communication device relaying transmission of the transmission port information from the second communication device to the first communication device is instructed to return the data received from the first communication device by the third communication device to the first communication device.

### Supplementary Note 7

A communication system comprising:

a first communication device transmitting data in a first layer;

a second communication device transmitting, to the first communication device, transmission port information indicating a port from which the data are transmitted, in a second layer higher than the first layer; and

a control device transmitting a processing method of the data based on a destination of the data to the second communication device and when detecting occurrence of a failure in the second communication device, transmitting the transmission port information determined based on a destination of the data to the first communication device.

### Supplementary Note 8

The communication system according to Supplementary Note 7, wherein

the processing method is processing for transmitting the data through the first communication device other than the first communication device connected to the second communication device in which the failure has occurred, out of a plurality of the first communication devices, and

the control device transmits the transmission port information to the first communication device other than the first communication device connected to the second communication device in which the failure has occurred.

### Supplementary Note 9

The communication system according to Supplementary Note 7, wherein

the processing method is the transmission port information for the first communication device connected to the second communication device in which the failure has occurred, and

the control device transmits the transmission port information to the first communication device connected to the second communication device in which the failure has occurred.

### Supplementary Note 10

A communication method comprising:

transmitting a processing method of data based on a destination of the data to a second communication device transmitting, in a second layer higher than a first layer, transmission port information indicating a port from which the data are transmitted, to a first communication device transmitting the data in the first layer; and,

when detecting occurrence of a failure in the second communication device, transmitting the transmission port information determined based on a destination of the data to the first communication device.

### Supplementary Note 11

A computer-readable recording medium having a control program recorded thereon, the control program causing a computer to provide a function of:

transmitting a processing method of data based on a destination of the data to a second communication device transmitting, in a second layer higher than a first layer, transmission port information indicating a port from which the data are transmitted, to a first communication device transmitting the data in the first layer; and,

when detecting occurrence of a failure in the second communication device, transmitting the transmission port information determined based on a destination of the data to the first communication device.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-187788, filed on Sep. 28, 2017, the disclosure of which is incorporated herein in its entirety by reference.

### REFERENCE SIGNS LIST

10A Control device
11A Communication unit
12A Management unit
13A Failure monitoring unit
20A Second communication device
21A Communication unit
22A Transfer processing unit
30A First communication device
10 Controller
11 Communication unit
12 Path management unit
13 Failure monitoring unit
14 Network information storage unit
20, 20-1, 20-2, 20-3 Higher level communication node
21 Communication unit
22 Transfer processing unit
23 Processing method storage unit
30, 30-1, 30-2, 30-3 Lower level communication node
31 Communication unit
32 Transfer processing unit
33 Processing method storage unit
40, 40-1, 40-2, 40-3 Medium-level communication node
41 Communication unit
42 Transfer processing unit
43 Processing method storage unit

1. A control device comprising unit for:
transmitting a processing method of data based on a destination of the data to a second communication device transmitting, in a second layer higher than a first layer, transmission port information indicating a port from which the data are transmitted, to a first communication device transmitting the data in the first layer; and,
when detecting occurrence of a failure in the second communication device, transmitting the transmission port information determined based on a destination of the data to the first communication device.

2. The control device according to claim 1, wherein
the processing method is processing for transmitting the data through the first communication device other than the first communication device connected to the second communication device in which the failure has occurred, out of a plurality of the first communication devices, and
the control device transmits the transmission port information to the first communication device other than the first communication device connected to the second communication device in which the failure has occurred.

3. The control device according to claim 1, wherein
the processing method is the transmission port information for the first communication device connected to the second communication device in which the failure has occurred, and
the control device transmits the transmission port information to the first communication device connected to the second communication device in which the failure has occurred.

4. The control device according to claim 1, wherein
a communication line connecting the first communication device and the second communication device is connected through a working interface and one or more standby interfaces, and,
when a failure occurs at the working interface, the control device instructs the first communication device and the second communication device that use the working interface to use the standby interface.

5. The control device according to claim 1, wherein
the first layer is an optical layer, and the second layer is an IP layer.

6. The control device according to claim 1, wherein,
when occurrence of a failure is detected in at least one of the second communication devices,
a third communication device relaying transmission of the transmission port information from the second communication device to the first communication device is instructed to return the data received from the first communication device by the third communication device to the first communication device.

7. A communication system comprising:
a first communication device transmitting data in a first layer;
a second communication device transmitting, to the first communication device, transmission port information indicating a port from which the data are transmitted, in a second layer higher than the first layer; and
a control device transmitting a processing method of the data based on a destination of the data to the second communication device and when detecting occurrence of a failure in the second communication device, transmitting the transmission port information determined based on a destination of the data to the first communication device.

8. The communication system according to claim 7, wherein
the processing method is processing for transmitting the data through the first communication device other than the first communication device connected to the second communication device in which the failure has occurred, out of a plurality of the first communication devices, and
the control device transmits the transmission port information to the first communication device other than the first communication device connected to the second communication device in which the failure has occurred.

9. The communication system according to claim 7, wherein
the processing method is the transmission port information for the first communication device connected to the second communication device in which the failure has occurred, and
the control device transmits the transmission port information to the first communication device connected to the second communication device in which the failure has occurred.

10. A communication method comprising:
transmitting a processing method of data based on a destination of the data to a second communication device transmitting, in a second layer higher than a first layer, transmission port information indicating a port from which the data are transmitted, to a first communication device transmitting the data in the first layer; and,
when detecting occurrence of a failure in the second communication device, transmitting the transmission port information determined based on a destination of the data to the first communication device.

11. (canceled)
